(19) United States
(12) Patent Application Publication
(10) Pub. No.: US 2026/0066815 A1
(43) Pub. Date: Mar. 5, 2026

(54) INFINITE AUTO POWER GENERATION DEVICE FOR POWER GENERATION, STORAGE AND AMPLIFICATION

(71) Applicant: Pietov RAZANAJATOVO, Galway (IE)

(72) Inventor: Pietov RAZANAJATOVO, Galway (IE)

(21) Appl. No.: 19/106,217

(22) PCT Filed: Aug. 26, 2023
(86) PCT No.: PCT/IB2023/000467

§ 371 Date: Feb. 25, 2025

(30) Foreign Application Priority Data
Aug. 26, 2022 (IE) 2022/163

(51) Int. Cl. H02N 11/00; H02J 7/00; H02J 7/14; H02J 7/34

(52) U.S. Cl. CPC H02N 11/008; H02J 7/1423; H02J 7/345; H02J 7/50

(57) ABSTRACT

The present invention relates to infinite auto power generation device No: 1 to 19 that can be used together in products to generate, store, amplify mechanic, DC, AC power without using external power, made with:
(rechargeable) batteries or capacitors or electrical transformers with same voltage but different powers connected in parallel and/or in series,
or insulated capacitor with 2 different electrodes separated by an insulator, (with holes)
or magnet(s) & diodes with coils/transformers kept in a HV insulator,
or transformers and electric motors with insulated magnetic alloy wire coils,
or at least 1 circular magnet on an axis with magnet(s) with rod, U or other form,
or at least 2 torsaded insulated wires separated by a HV insulator, kept insulated.
or by using diodes, resistors, capacitors transistors between 2 batteries
or by using 2 inverted diodes on parallel kept on HV insulator

### FIELD OF THE INVENTION

The present invention relates to infinite auto power generation devices used for generating and storing DC and AC electrical and mechanical power such as batteries, battery charger, capacitor, electrical transformer, dynamo, motor, that produce electric, mechanical power continuously without need from an external energy source (whether mechanical, electric, caloric, thermal, . . . ) and relates to the manufactoring of new type of batteries, generators, capacitors, transformers, motors and related manufactured products using these new types of infinite auto power generation device that allow continuous electrical and/or mechanical power generation for these products without need for external power.

### BACKGROUND TO INVENTION

Power generator and storage devices such as (rechargeable) batteries, (storage) capacitors, electrical transformers, dynamo, motor . . . need an initial power source to store, transform, recharge or generate power, for example:
1—battery and storage capacitor when used can, (if rechargeable) be recharged with a battery charger
2—electrical transformer(s) need electrical power that is converted, transformed to a different voltage, current, . . .
3—dynamo(s) need mechanical and/or electric power, to generate electric power, . . .
4—electrical motor need electricity, to generate mechanical power
5—mechanical motor (in car, train, plane, ship's engine), need gas, petrol, coal . . . to generate mechanic, electric, . . . power

These electrical and mechanical power generators: motors, chargers, transformers and storage devices need external electrical, mechanical, . . . power to function continuously that may come from oil, wind, solar energy, nuclear energy, bio-energy conversion, burning of coal, wood . . . .

These mineral resources (oil, coal, gas, . . . ) are limited on earth and are according to scientists creating detrimental weather modification for humanity and earth (by increasing the climate, temperatures worldwide, . . . ), while conventional nuclear power station, are potentially life threatening when accidents happens, . . . .

(As did happen with Tchernobil, Fukishima, Three miles island, . . . nuclear power stations). It is desirable that power generators, transformers, storage devices, generate, transform, store power without harming the earth, . . . and humanity, while also being easy and cheap to build and reliable continuously.

Accordingly, there is a need for infinite auto power generation device(s) used as generator and storage devices that offer these advantages to improve life conditions for domestic, public and private use for humanity and to maintain peace on earth because disputes over limited mineral resources (oil, coal, natural gas, . . . ) used to power cars, trains, ships, planes, cities, . . . have caused wars on earth.

And I am applying for my invention(s) to never being used for dangerous applications worldwide by forever forbidding it being used for/by military activities, and/or defence agencies, and/or being confiscated . . . for all times, and for any infinite auto power generation device's benefit(s) to be used for peaceful activities only.

Accordingly, there is need for continuous electric and mechanic auto power generation with the invention that use a combination of a few modified batteries and/or capacitors and/or a few generators and/or a few electrical transformers, (zener) diodes, magnets, high voltage (anti-static) insulators, metal foils, (insulated) wires, and/or motor(s) that are build in an other way, that is different from their usual general descriptions shown below:
1—Usual battery has and anode (made of metal, or rod of coal, . . . ) with a + pole and a cathode with a − pole that is usually made of metal) and an electrolyte that is an acid (or base), the typical voltage is about 1 volts. Some batteries with higher voltages are build with batteries of ^{˜}1 volt connected in series s with the − pole connected to the + pole of the other battery. For example; for a battery of 4.5 volts; 3 batteries of 1.5 volts are connected in series s.
2—Usual rechargeable batteries are usually similar to batteries, but cathode (−) and anode (+) and electrolyte are chosen with materials, and electrolyte that allow the batteries to discharge energy, and being recharged again and again by applying a higher current and a higher voltage to the rechargeable battery.
3—Usual (storage) capacitor (and other capacitors) are very similar to batteries, and can be used as power storage device for power generation that can be recharged again, both polarized capacitors and non polarized (high or low frequency) capacitors are made of 2 similar electrodes separated by insulator(s).
4—Usual electric transformers are made with a core of magnetic steel (silicon steel, iron-nickel alloys, ferrite, . . . ) with primary coil(s) and secondary coil(s). The primary (input) coil has an alternating current & voltage transformed in the secondary (output) coils with a higher or lower voltage and/or current or both depending on the number of spires, the size of the coils, and insulated wires (usually in copper) in the primary (input) and in the secondary (output), and depending also on the core made with alloys used in the transformer.
5—Usual electrical power generator is made with magnets and/or electromagnet with a strong magnetic field where the coil(s) is/are rotating (within the rotor).

The alternating magnetic field generated in the rotating coils creates an inductive current, with a voltage depending on the frequency of the rotation of the rotor. (Some generators have fixed coils, while the (electro-) magnets are rotating, or moving to create an inductive current in the coils).
6—Usual mechanical power generator are usually motors powered or needing steam, gasoline, gas or electricity to generate a rotating mechanical power that is transmitted mechanically (by an axis) that can also produce electric power when connected by their axis to an electric generator (dynamo).

These devices mentioned above that initially need power to produce, store, . . . power continuously, can be improved with my invention to produce and/or store power (energy) continuously without adding external energy (power) by using infinite auto power generation devices, made with improved use of the devices mentioned above in 1, 2, 3, 4, 5, 6.

### SUMMARY OF THE INVENTION

According to the invention there is provided, as set out in the appended claims, a few models of infinite auto power generation devices:
infinite auto power generation device 1: is an auto rechargeable battery made of at least 3 (rechargeable) batteries with 3 different power storage and same voltage in parallel with a switch
infinite auto power generation device 2: is an auto rechargeable battery made of 2 sets of 2 (rechargeable) batteries with 2 set of different power and 4 same voltage in parallel & in series s with a switch
infinite auto power generation device 3: is an auto rechargeable charger made of 2 or 3 or 4 (rechargeable) batteries with different power storage and same voltage in parallel & in series s with a switch
infinite auto power generation device 4: is an auto rechargeable charger made of 2 or 3 or 4 (storage) different capacitors with same voltage in paralleled & in series s with a switch
infinite auto power generation device 5: is a AC power generator made with at least 3 (high and/or low frequency) different capacitors values with same voltage in parallel with a switch or resistor
infinite auto power generation device 6: is a AC power generator made with at least 3 transformers with same voltage but 3 different power in parallel,
infinite auto power generation device 7: is a AC power generator made with 1 or 2 new type of transformers in a loop, using insulated magnetic alloy wires in the input coil and insulated non magnetic alloy wire in the output coil
infinite auto power generation device 8: is a AC power generator made with (a) coil(s) with a core near an insulated magnet vibrating when connected at its both extremities to 2 insulated inverted diodes in parallel,
infinite auto power generation device 9: is a mechanical power generator (or motor) made with a circular magnet spinning on an axis by magnetic force created by movable/fixed magnet(s) in rod, C, U, . . . form near the circular magnet
infinite auto power generation device 10: is a mechanical & AC power generator made with a circular magnet with holes surrounded by coils that is spinning on an axis by magnet(s) in rod, U, . . . form near the circular magnet
infinite auto power generation device 11: is a new type of AC/DC electric motor made with coils using insulated magnetic alloy wires (that increase more the alternating magnetic field in the coils and in the rotor/stator of the motor that can be connected by their axis to a dynamo powering electrically the new type of motor.
infinite auto power generation device 12: is a AC & DC power generator made with disymetric capacitor(s) that has 2 electrodes with different sizes separated by a thin HV insulator that are kept insulated by a high voltage insulator
infinite auto power generation device 13: is a transformer and AC & DC power generator made with 2 insulated electric wires separated by a HV insulator spinned against each other in the middle of their length, and kept in a HV insulator
infinite auto power generation device 14: is an electron/ion beam & plasma generator made with modified insulated disymetric capacitor with 2 electrodes of different sizes with each a hole, separated by a thin HV insulator with a hole
infinite auto power generation device 15: is a High power HV & high frequency AC & DC power generator made with 2 or more disymetric capacitors (with 2 insulated different wires separated by a HV insulator) in series s, parallel or loop
infinite auto power generation device 16: is a AC & DC power generator made with insulated electric wires separated by a HV insulator spinned against each other at the end of their length, and kept in a HV insulator.
infinite auto power generation device 17: is an auto rechargeable battery made of at least 3 (rechargeable) batteries with the same voltage and similar power with at least 1 or 2 diode, a capacitor, a resistor, a transistor, that can be replaced by more than 50 diodes in parallel, or by an integrated chip containing only diodes in parallel or diodes, capacitors, resistors, transistor
infinite auto power generation device 18: is an auto power electron beam generator made with at least 2 diodes in anti-parallel and a HV insulator producing continuously, without adding power an electron beam.
infinite auto power generation device 19: is a AC current generator using 2 infinite auto power generation device with an electronic circuit.

Improved infinite auto power generation device (I.A.P.G.D) use I.A.P.G.D together.
1—Infinite auto power generation device 1 & 2 used as a basic power generator and storage device is battery producing and storing DC power,& current with any voltage, power continuously without adding external power build with: a combination of (rechargeable) batteries and/or (storage capacitors with similar Voltage (V) and different powers storage (W/h) and/or capacitors with different capacities (F), that are connected in parallel (pole + to pole + & − pole − to pole −) and can be also in series s (pole + to pole −); where the (rechargeable) batteries and/or capacitors auto-recharge themselves continuously without adding external power. At least 1 relais and a zener diode or at least 2 or 3 inverted diodes in parallel (FIG. 1.d or FIG. 1.e or FIG. 1.f) let the current go from pole + (or −) (of the battery with highest power to pole + (or −) of the battery that has to be charged that has the next lower power, (to prevent the batteries discharging).
2—Infinite auto power generation devices 3 & 4 used as power generator is a charger for a (re-chargeable) battery, or (storage) capacitor producing DC power continuously without adding external power by auto recharging itself that is build with: at least 2 (rechargeable) batteries and/or (storage) capacitors with similar Voltage (V) and 2 different power (W/h) or different capacities (F) that are connected in parallel (+ pole to the + pole. and − pole to − pole); the (rechargeable) batteries and/or capacitors from the charger auto-recharge themselves continuously (without external power) when connected to the (rechargeable) battery to recharge. A circuit with diodes, relais called: ‘circuit 162’ (FIG. 1.d & FIG. 1.e & FIG. 1.f) should be added to avoid discharge of the (rechargeable) battery that has to be (re-)charged with the charger by acting as switch with the charger.
3—An infinite auto power generation device 5 used as high voltage power generator made with (high and/or low frequency) capacitors, and (polarized) capacitor to generate AC or DC power continuously without adding external power is build with a combination of at least 3 (high or low frequency, or polarized) capacitors with similar Voltage (V) and different capacity (F) connected in parallel that are auto-recharging themselves when kept insulated with a high voltage (HV) (anti-static) insulator to produce AC, or DC power continuously without adding external power, and can be used as an auto rechargeable AC or DC charger and/or AC or DC power generator generating power continuously without adding external power. These capacitor(s) and other connected device need to be kept insulated by a HV insulator while generating DC or AC power.
4—An infinite auto power generation device 6 used as an AC power generator made with transformers that can generate (high or low) frequency AC current & power continuously without adding external power that is build with: the inputs (and outputs) of at least 3 electrical transformers with similar voltage (V) and 3 different power (W/h) are connected in parallel (and in phase), the transformers can auto-recharge themselves and produce AC power continuously (after using an initial AC power that is not needed later). The principle used for continuous alternating current (AC) auto power generation without added external power is the same principle used with DC auto power generation where the 3 (or more) rechargeable batteries that are connected in parallel to produce continuous DC power as explained (1—p 7 & 8). The 3 parallel outputs can be connected to input of transformer 4, whose output is connected to a circuit letting AC current go only 1 way: to the 3 parallel inputs of the 3 other transformer to form a loop.
5—An infinite auto power generation device 7 used as an AC power generator made with a new type of transformers that generate (high or low frequency) AC current and power continuously without adding external power is build with a combination of at least 1 or 2 new type of transformers that are made with output coils using insulated copper wires, and input coils made with insulated magnetic alloys wires. These 2 new type of transformers have the output coil of the 1rst new type of transformer A connected to the input coil of the 2sd new type of transformer B, and the output coil of the 2sd new type of transformer B can be connected (with a circuit using diodes to let AC power flow only to) to the input of the 1rst new type transformer A (in a loop), that let the 2 new type of transformers auto-recharge themselves and produce more power continuously without adding any external power.
6—An infinite auto power generation device 8 used as AC power generator made of insulated magnet, diodes, HV (anti-static) insulator, coils with or without a core that can generate AC power continuously power without adding external power is build with a combination of coil(s) with or without a core, or transformers, magnet(s), diodes and a HV (anti-static) insulator that let the magnet vibrate continuously near the core of the transformer or core of a coil. By short-circuiting repeatedly the low AC voltage at both ends of the insulated magnets through 2 insulated inverted diodes; a vibrating magnetic field is created by the repeated magneto-contraction & de-contraction of the magnet placed near the core of the transformer, creating continuous AC power in the coil(s), transformer's coil that are build to resonate with the magnet's vibrating frequency.
7—Infinite auto power generation devices 9 & 10 used as a mechanical power generator (or motor) that can be build (modified) to be used as both an AC/DC power generator (a dynamo) and a mechanical power generator producing mechanic and electric power continuously without adding external power, it is build:
   by using 1 circular magnet (that can have holes along its circumference with nearby 2 coils connected in (inverted) series s in a C shape with a core made of magnetic alloy to generate AC power), and other magnet(s) with button, rod, C, U or other form that can adjust (around their own axis) the (variable) angles/position near or around the circular magnet that is connected to a rotor turning on its axis.

These magnet(s) with a rod or C or U, . . . form produce a variable magnetic force (depending their angle, distance) against the circular magnet spinning on its axis that generate a variable mechanical (convertable to AC) power continuously without external power.
8—An infinite auto power generation device 11 used as mechanical power generator is a new type of electrical motor that is build:
   by using coils made with insulated magnetic alloy wires (that increase more the alternating magnetic field in the coils of the rotor) in a motor using AC/DC current, that increase more the power output of the motor (DC/AC power) than a motor made with insulated copper wire coils (or non-magnetic alloy wire). If this new type of motor is connected by their axis to a dynamo it produce AC/DC electrical & mechanic power continuously without adding external power by electrically powering the motor with a part of dynamo's power output.

The insulated magnetic magnetic alloys wires can be for example: insulated silicon steel wire (Fe (95%), Si (^{˜}5%) or insulated iron-nickel alloy wire (Fe (30-70%), Ni (70-30%), . . . ) . . . that increase the alternating magnetic field created by DC & AC more in the coils and in the core of the rotor or stator of the new type of motor, increasing the mechanical output power of the new type of electric motor than usual motor using coils with insulated copper wire.
9—An infinite auto power generation device 12 used as AC power generator producing high voltage and high frequency AC& DC electro-(static) power is build with disymetric capacitor(s); that are made with 2 electrodes with different sizes, volumes separated by a thin HV insulator, producing continuously negative − charge on the largest electrode and positive + charge on the smallest electrode, that produce continuously high voltage, static electricity, ionized air, . . . . Disymetric capacitors can act as charge amplifier and polarity inverter when kept insulated by high voltage (anti-static) insulator and can be connected in series s, parallel, in loop(s)
10—An infinite auto power generation device 13 used as a transformer and AC & DC power generator to increase or decrease input voltage and/or current that is build with 2 insulated electric conductors (wires, . . . ) that are separated by a HV insulator spinned, torsaded, . . . against each other in the middle of their length, and kept insulated in a very HV (anti-static) insulator case (paraffine for example). The inputs and outputs of this transformers are on the 2 extremities of the 2 insulated wires, that generate in the output: (depending on the numbers of spires on each of the 2 conductors);
1—an increased/decreased input voltage/current in the output wires,
2—the polarity at the end of each insulted output wires;
3—and whether the output is DC & AC or only AC voltage.

At least 2 transformers in parallel, series s, in loops produce continuously HV static power (ionized air, . . . ) without external power when kept insulated with a HV insulator.
11—An infinite auto power generation device 14 used for as electron/ion beam or HV voltage electro(-static) generator made with modified disymetric capacitor is build: with a disymetric capacitor, that has 2 electrodes with different sizes with a hole that are separated by a thin HV insulator with a hole, producing electrons/ions beam in the hole flowing from the negative − charged largest electrode to the positive + charged smallest electrode, producing continuously ionized air, or thrust for engines in space using plasmas or beam particles to move (space)craft in space (air or vacuum). The 2 disymetric electrodes with hole(s) can be separated by HV insulator(s) without hole, (separating gas(es) or air & vacuum or liquid (water) & gases) if thin enough and permeable to gases but not water that let positive + ions (hydrogene) & negative − ions (oxygene) flow through the holes of the 2 electrodes & insulator (without or with hole) continuously without external power.
12—An infinite auto power generation device 15 used as High power HV and high frequency AC& DC power generator and/or an electrons/ions beam generator is build: with at least 2 or 3 disymetric capacitors (made with 2 insulated conductors separated by HV insulator) connected in series s and loop that are acting as amplifier & inverter of charge & polarity that create a higher voltage & intensity of the electron beam created between the anode + (in the form of a ring) and the cathode − (in the form of a point of a needle, as an example); for electrons/ion beam generation. This device can also be used for thrust engine in space or as HV static electricity generator or to charge HV capacitors.
13—infinite auto power generation device 16: is a AC & DC power generator build with 2 insulated electric wires with similar or different size separated by a HV insulator spinned against each other at the end of their length, and kept in a HV insulator, the wire with the largest size (length, diameter, . . . ) generate a negative charge (alternating), while the other smaller wire has a positive (alternating) charge, if both wires have similar size, it act as a transformer.
14—infinite auto power generation device 17: is an auto rechargeable battery and/or battery charger build with at least 3 (rechargeable) batteries: battery 1, battery 2, battery 3 with similar voltage and power and at least 1 or 2 diode, a capacitor, a resistor, a transistor that are connected between battery 1 and battery 2, that are recharging battery 3 without adding power, and without discharging battery 1 and battery 2.
15—infinite auto power generation device 18: is an auto power electron beam generator made with at least 2 inverted fast switching diodes (1n4148 or schottky diodes) in parallel that are kept insulated by a HV insulator (for example; Paraffine paper, PET, paper with oil, . . . ), producing at one extremity in the form of a circle a positive voltage and at the other extremity in the form of a needle point a negative voltage, an electron beam is produced continuously without external adding power.
15—infinite auto power generation device 19: is an AC current generator that charge alternately 2 or more (rechargeable) batteries, by using the circuit used by 2 auto power generation 17 that let the current go in 2 direction when alternately 1 of the 2 circuits is activated and the other circuit is deactivated.

A combination of infinite auto power generation device(s) from my invention can be used in different combinations together to produce, store power that can be used for example in: electric power stations, power station producing hydrogene, power station for factories, or in building, spacecraft engines, hydrogene production, . . . .

The novelty & advantages of my invention with 18 infinite auto power generation devices summarized in 1, 2, 3, 4, 5, 6, 7, 8, 9, 10, 11, 12, 13, 14, 15 and any combination of these devices together is to produce very cheap electrical & mechanical power continuously without need for added external power & it is easy to manufacture by using cheap products already available and safe by not producing dangerous, toxic by-products.

### BRIEF DESCRIPTION OF THE DRAWINGS

The invention will be more clearly understood from the following description and embodiment thereof, given by way of examples, with references to the accompanying drawings, that are electrical schema and drawing of the the devices, in which:

FIG. 1.a shows a structure of the invention; infinite auto power generation device 1 used as DC power generator and storage device made with (rechargeable) batteries to build a:
auto power generating battery of about 1 Volt producing DC power& current continuously without adding external power, (without a circuit to stop discharge).

FIG. 1.b and FIG. 1.c and FIG. 1.d and FIG. 1.e and FIG. 1.f shows 2 different structures of the invention; infinite auto power generation device 1 used as DC power generator and storage device made with (re-chargeable)batteries and a circuit acting as switch to avoid discharge with (zener) diodes (& relais, transistor, resistor), build:
in a infinite auto power generation battery generating DC power & current with 7,5 Volts and power storage of 1 W/h, producing power continuously without adding external power by adding 1 of the 3 equivalent circuits called ‘circuit 162’ (in FIG. 1.d & FIG. 1.e & FIG. 1.f) to avoid discharge of the auto generation battery of 7,5 V.

FIG. 1.g show a structure of the invention; infinite auto power generation device 3 used as DC power generator & storage device made with (rechargeable) batteries to build:
an infinite auto power generation device used as charger of (rechargeable) battery/ies that work continuously without adding external power while charging. (1 of the 3 circuits of ‘circuit 162’ can used to avoid discharge of the battery to recharge with the charger).

FIG. 1.h shows a structure of the invention; infinite auto power generation 2 used as DC power generator and storage device made with (rechargeable) batteries to build: an auto power generating battery of about 24 Volt, 40 A producing DC power& current continuously without adding external power, (with 2 switch to stop discharge).

FIG. 2.a shows a structure of the invention; infinite auto power generation device 5 used as AC power generator device made with (high or low) frequency capacitors (F), (MKP) to build:
an infinite auto power generation device used as AC power generator producing (very high or low frequency AC current) continuously without adding external power.

FIG. 2.b shows a structure of the invention; infinite auto power generation device 4 used as DC power generator & storage device made with polarized capacitors; electrolytic supercapacitors, ultra capacitor, . . . to build:
an infinite auto power generation device used as DC generator producing and storing DC current continuously without adding external power.

FIG. 2.c shows a structure of the invention; infinite auto power generation device 4 used as DC power generator & storage device made of storage capacitors to build:
an infinite auto power generation device used as charger to recharge (storage) capacitors with DC power & DC current continuously without adding external power.

FIG. 2.d shows a structure of the invention; infinite auto power generation device 12 used a HV electro-(static) generator made with at least one new type of capacitor, (that I call) disymetric capacitors containing two electrodes with different sizes separated by a high voltage (HV) (anti static) insulator to build an
infinite auto power generation device (that I call); a disymetric capacitor producing continuously and spontaneously without adding any external power; negative − charges on the largest electrode and positive + charges on the smallest electrode, when the disymetric capacitor is kept isolated with a HV insulator.

The quantity of electric charges in the 2 electrodes of the (disymetric) capacitor produce power continuously without external power; (HV static electricity, ionized air, . . . ).

FIG. 2.e show a structure of the invention; infinite auto power generation device 14 used as a electron/ion beam generator made with a disymetric capacitor that contains a HV insulator with a hole separating a large and a smaller electrodes with both at least one (small) hole to build:
an infinite auto power generation device used to produce continuously and spontaneously without adding external power electrons/(or ions) beam(s) that can be used for ionizing air or for space engine using (continuous)charged particles beam(s) for a thrust engine in space, (that does not need any external added power).

FIG. 2.f shows a structure of the invention, infinite auto power generation device 16 used a AC & DC power generator and amplifier and inverter of polarity and charge made with a disymetric capacitors to build:
an infinite auto power generation device made with at least 2 insulated conductors (with different size) separated by a HV anti-static insulator and torsaded, spinned through a part of their length with each other at one of their extremities. Both other extremities of the 2 conductors that are non insulated produce an increasing DC & AC (if 2 different wire size) or only AC power (if 2 same wire size) at a high or very high frequency continuously without adding external power when kept completely insulated by a HV insulator and a in case in paper with paraffine; as an example. The extremities of the insulated longest/largest insulated wire has a negative − charge and the shortest, smallest insulated wire has a positive + charge that increase continuously without adding external power when kept insulated.

FIG. 2.g shows a structure of the invention; infinite auto power generation device 13 used as AC & DC or only AC power generator and transformer & amplifier & inverter of charge polarity if producing AC & DC power build:
in an infinite auto power generation device with at least 2 insulated conductors (with similar length and thickness) separated by a thin HV anti static insulator torsaded, spinned together at the middle of their length with each other,
   while the 2 other non insulated extremities of the 2 insulated conductors are the 2 inputs and 2 outputs of this device that:
   act as a transformer by increasing and/or decreasing an auto generated AC voltage and/or current with a high or low frequency continuously without adding external power when kept completely insulated by a HV insulator, (for example in a case with paper in paraffine, . . .
   and that can act as a high voltage AC generator (when both conductor have the same size), or as a DC & AC generator when both conductor have different sizes

FIG. 2.h shows a structure of the invention, infinite auto power generation device 15 used as HV AC &DC power generator made with 4 (insulated) conductors separated by 3 HV (anti-static) insulators forming 3 disymetric capacitors acting as amplifier and inverter and connected in a loop when kept in a case with a high voltage (HV) (anti-static) insulator to build:
an auto power generation device used as continuous HV (static) electricity generator and as a thrust engine producing continuously without adding any external power. The thrust is in the form of electrons (or ions) beam(s) device that can also be used for ionizing air, gas due to the amplified high negative (−) charges from the 3 disymetric capacitors connected in a loop and inverter to the initial conductor charged negatively − emitting electrons by a point of the needle (as an example) that are attracted and accelerated and go through the positively + charged ring connected to the amplified HV positive + voltage resulting from the inverter and amplifiers connected in a loop if circuit is kept insulated.

This infinite auto power generation device can also function as an air ionizer, plasma generator, . . . working continuously without added external power with an optimal result when this device is in a case or box that is filled with a very good High Voltage (HV), (anti static) insulator (for example, paraffine or oil, . . . )

FIG. 3.a shows a structure of the invention; infinite auto power generation device 6 used as AC power generator and AC power amplifier made with 3 or 4 electrical transformers to build:
an auto power generation device producing electric (high or low frequency) AC power continuously without need for continuous external added power by connecting in parallel and in phase the 3 inputs (and separately the 3 outputs) of at least 3 electrical transformers with similar voltage (V) and 3 different power (W/h). The 3 transformers can auto-recharge themselves & produce AC power continuously (after using an initial AC power), when the 3 parallel outputs are connected to the input of a 4 th transformer whose output is connected to a circuit that let the AC current flow only to 3 inputs connected in parallel (of the 3 other transformers), to connect them in a loop to generate more power.

FIG. 3.b shows a structure of the invention; infinite auto power generation device 7 used as AC power generator and AC power amplifier made with at least 1 or 2 new type of transformers to build:
an infinite auto power generation device used as AC power generator made of 2 new type of transformers with input coils using insulated magnetic alloys wire coils [insulated silicon steel wire (Fe (95%), Si (˜5%) OR insulated iron-nickel alloy wire (Fe (30-70%), Ni (70-30%), . . . ], . . . & output coils using insulated copper wires to produce more electrical power. More power can be produced by connecting the output of one new type of transformer A to the input of the other new type of transformer B that has its output connected to a circuit letting the AC current go only to the input of the new transformer A in a loop, (both transformer are then connected in a loop) to generate more AC power (with high or low frequency) continuously without adding external power.

FIG. 4 a & FIG. 4.b & FIG. 4.c & FIG. 4.d show 4 structures of the invention; infinite auto power generation device 8 used as AC power generator (low or high frequency) made with electrical transformers and/or coils with diodes and magnets with a button or a rod, tube or C or U or other form and HV insulator to build:
an infinite auto power generation device used as AC power generator generating AC power continuously without adding external power, created by the vibrating induction current created in coils that are caused by the vibrating magnetic field from the vibrating insulated magnet connected to 2 diodes short-circuiting repeatedly the low AC voltage at both ends of the insulated magnet, that let it contract & de-contract itself repeatedly.

FIG. 5.a and FIG. 5.b shows a structure of the invention; infinite auto power generation device 9 used as mechanical power generator (motor) that can also be used as AC/DC power generator & mechanic power generator in the infinite auto power generation device 10 shown in FIG. 5.c and FIG. 5.d made with at least 1 circular magnet (with holes and nearby its surface at least 2 coils with an alloy core in a C shape) & at least 1 or 2 other magnets in a new motor build-in an infinite auto power generation device used as mechanical power generator producing spontaneously and continuously mechanical power without adding external power, that can be converted to continuous electrical power production by connecting the motor and dynamo by their axis, or by adding holes on the circular magnet and coils near its surface

FIG. 6. shows a structure of the invention; infinite auto power generation device 11 used as mechanic power generator made with a usual electrical motor where the usual (copper) coils are replaced by insulated magnetic alloys wires[insulated silicon steel wire (Fe (95%), Si (˜5%) OR insulated iron-nickel alloy wire (Fe (30-70%), Ni (70-30%), . . . ) . . . ] that increase more the alternating magnetic field in the coils of the electric motor using AC/DC current (than motors made with coils with insulated copper wires) to build
an auto power generation device, used as an improved more powerful electric motor generating more mechanical power output (but using the same input electric power used in usual electric motor) that if connected by their axis to a dynamo produce more AC/DC and mechanical power continuously without adding external power, by letting a part of the electrical output of the dynamo powering electrically the new type of motor made with coils using insulated magnetic alloy wire(s).

FIG. 7.a illustrate an infinite auto power generation device 17 made with at least 2 or 3 similar electric (rechargeable) batteries of at least 1,2 Volt and of any power storage, as an example the − pole of battery 1 is connected to both cathodes of at least 1 or 2 diodes in parallel with − pole of an (electrolytic) capacitor of 1000 uF and to the emitter of an NPN transistor (BC547), while pole + of battery 2 is connected to the anodes of at least 1 or 2 diodes in parallel and to pole + of the electrolytic capacitor of 1000 uF and to the collector of the NPN transistor, and the base of the NPN transistor (BC547) is connected to a resistor and the other extremity of the resistor is connected to pole + of battery 2. Pole + of battery 1 is connected to pole + of battery 3 to charge and pole − of battery 2 is connected to pole − of battery 3 to charge.

FIG. 7.b illustrate an infinite auto power generation device 18 built with at least 2 inverted parallel diodes & anode with ring & needle point at the cathode on HV insulation.

FIG. 7.c illustrate an infinite auto power generation device 19 built with 2 circuits of 2 auto power generation device 17, and other components to activate alternatively one or the other circuit to generate an AC current that charge 2 (rechargeable batteries)

### DETAILED DESCRIPTION OF THE DRAWING

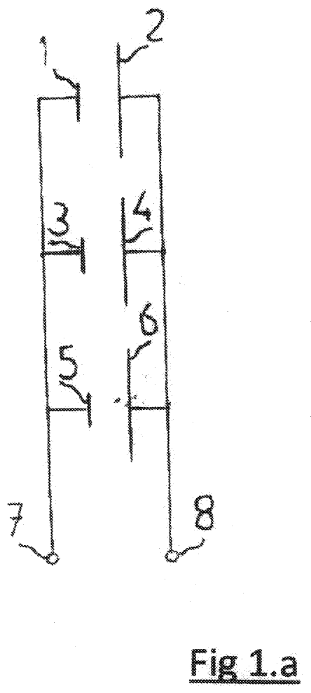

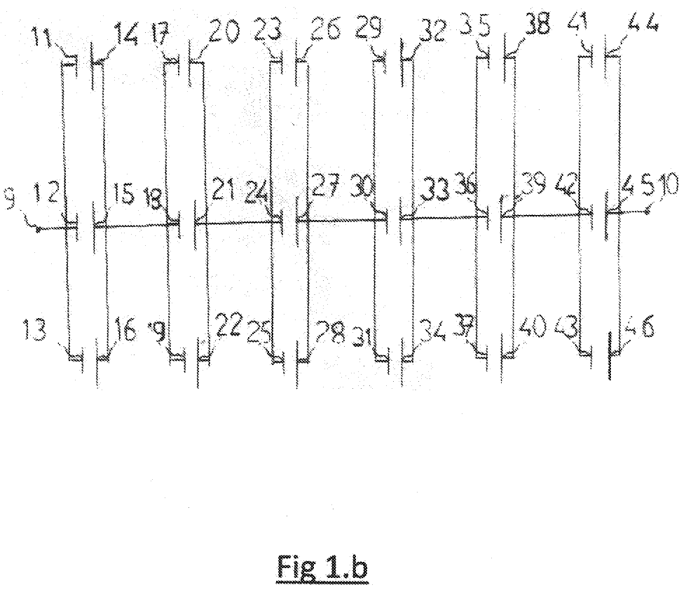

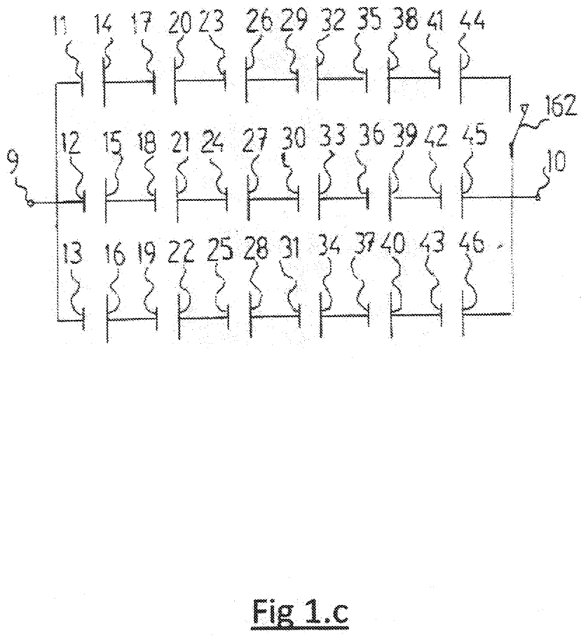

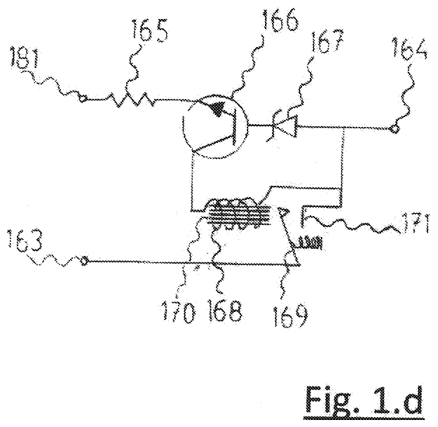

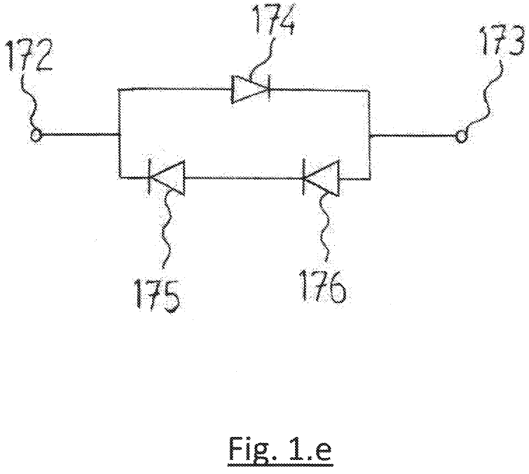

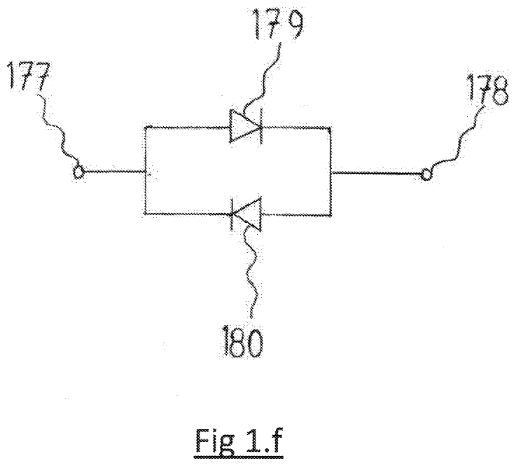

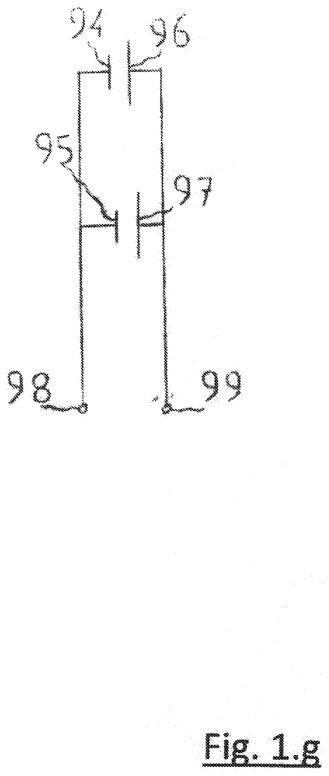

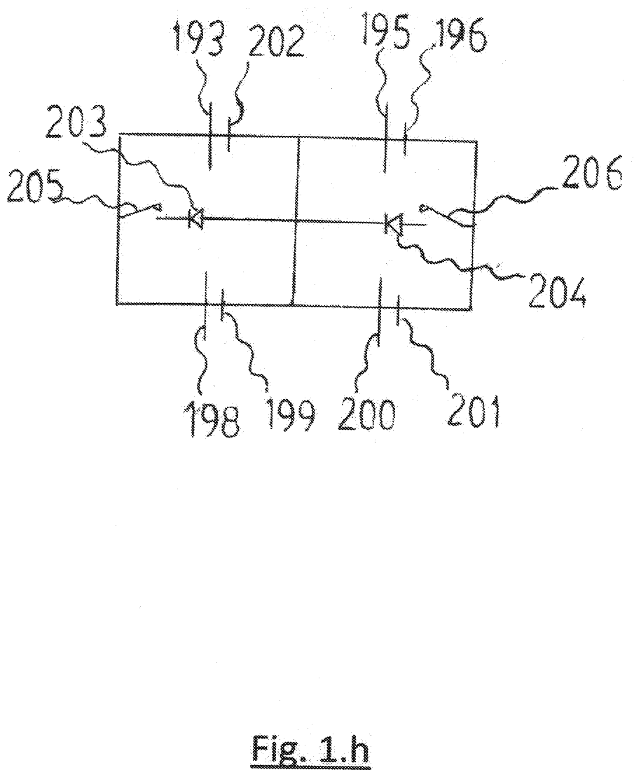

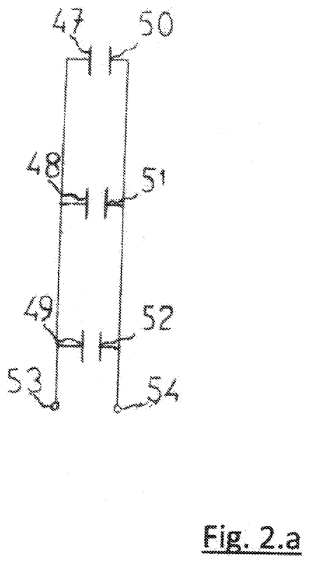

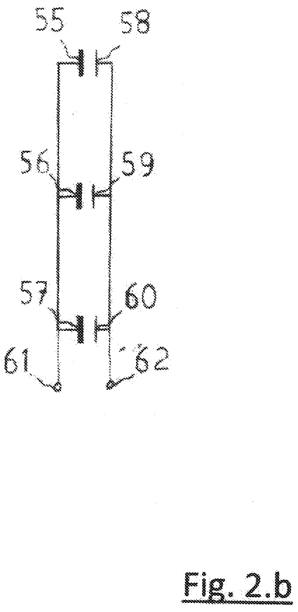

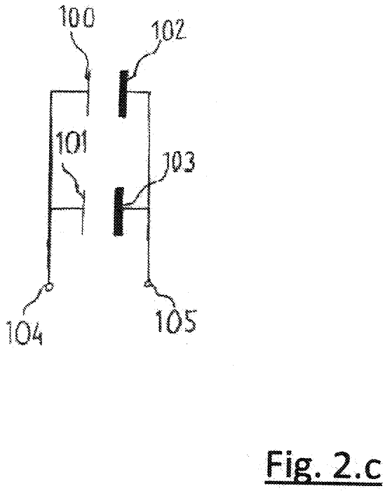

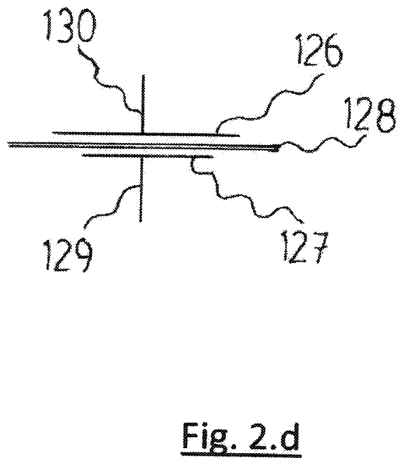

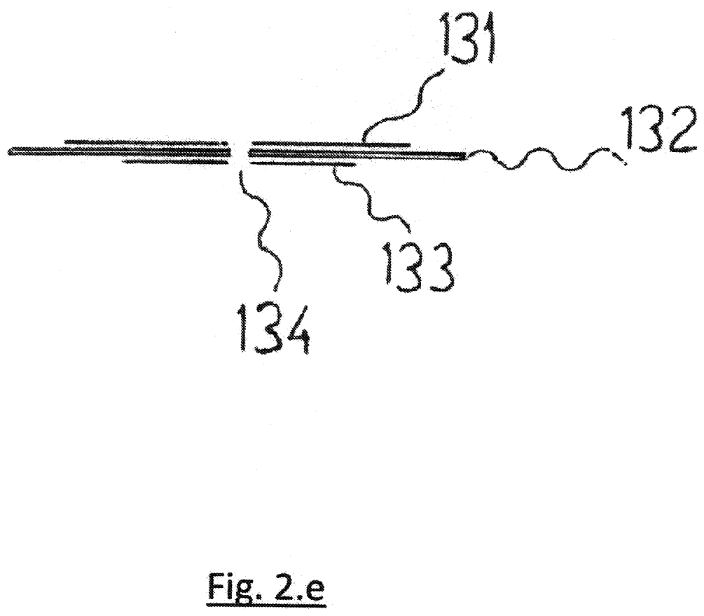

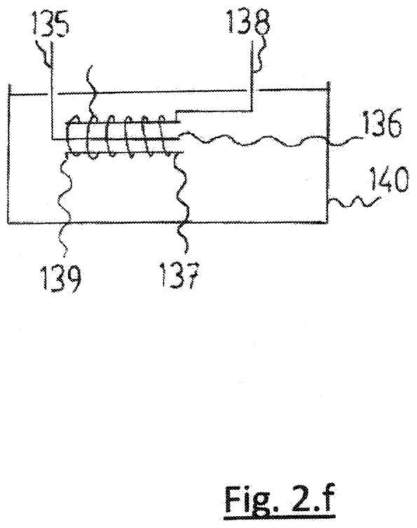

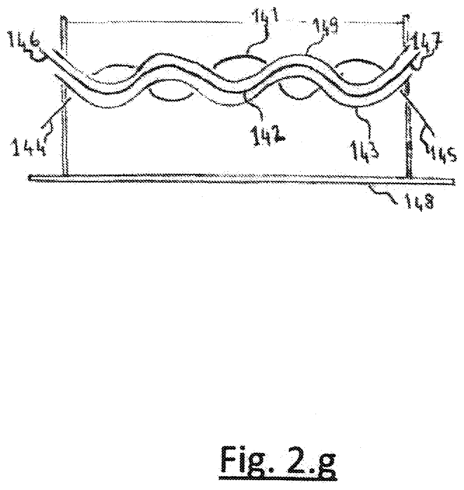

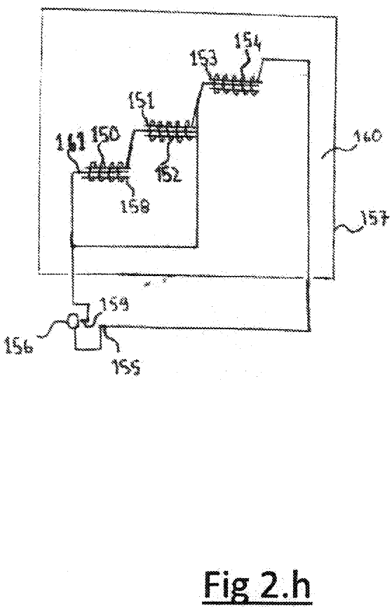

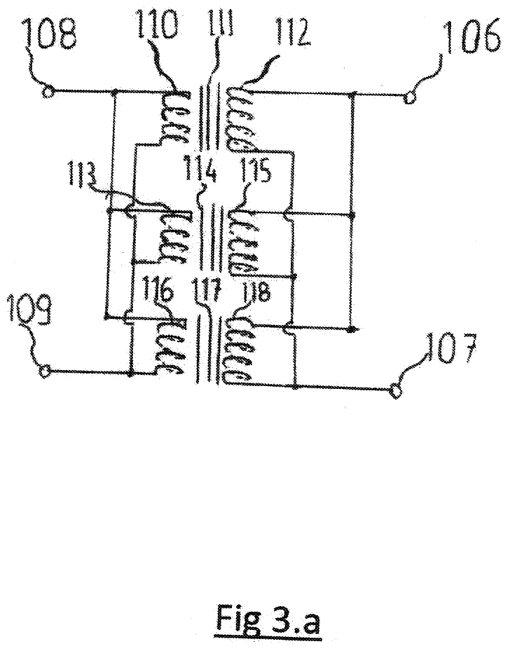

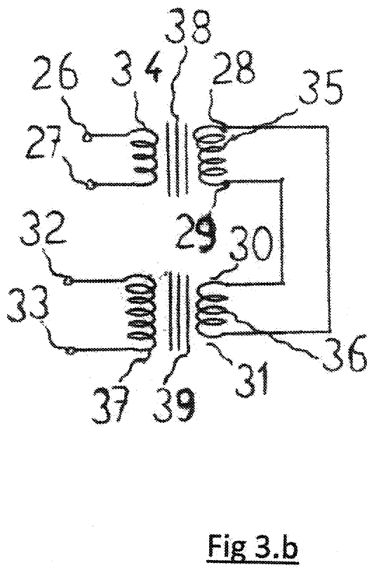

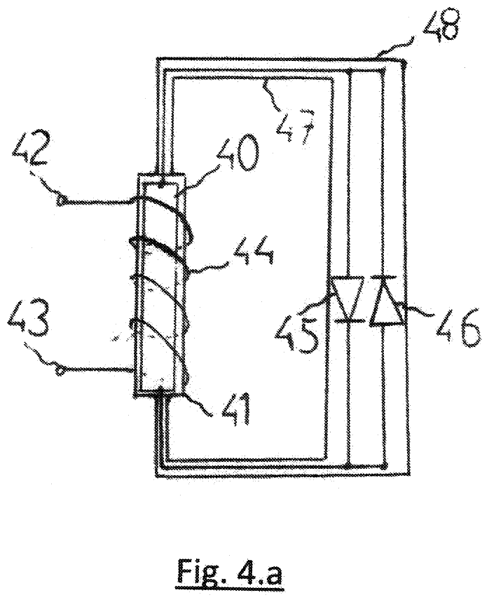

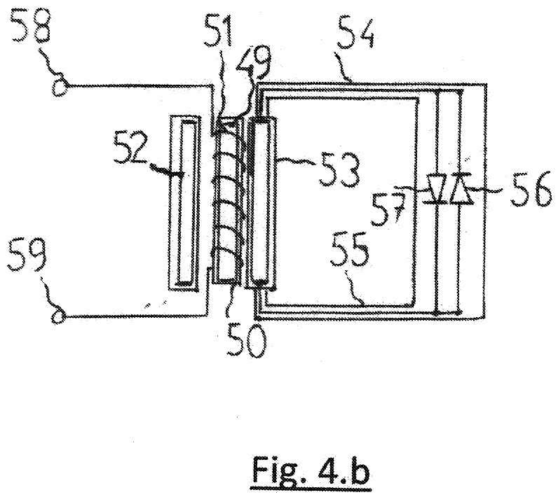

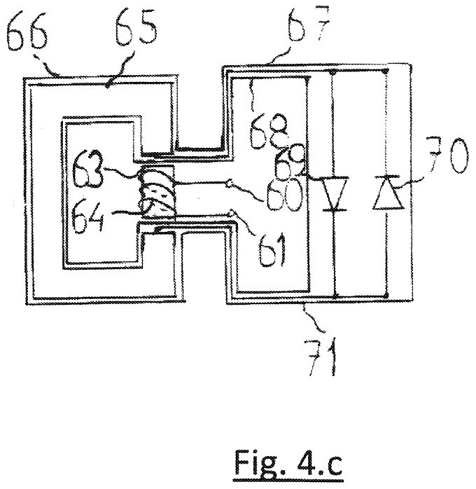

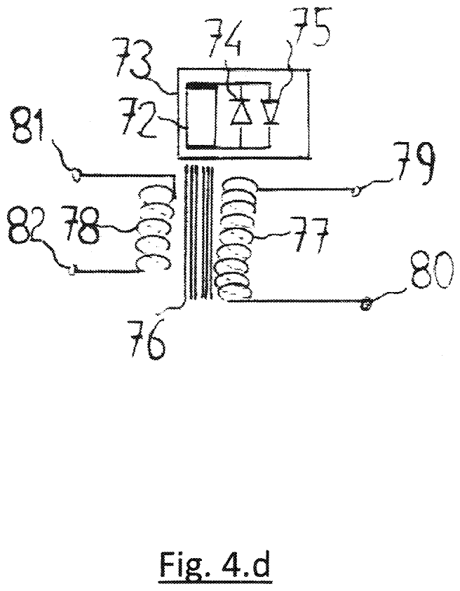

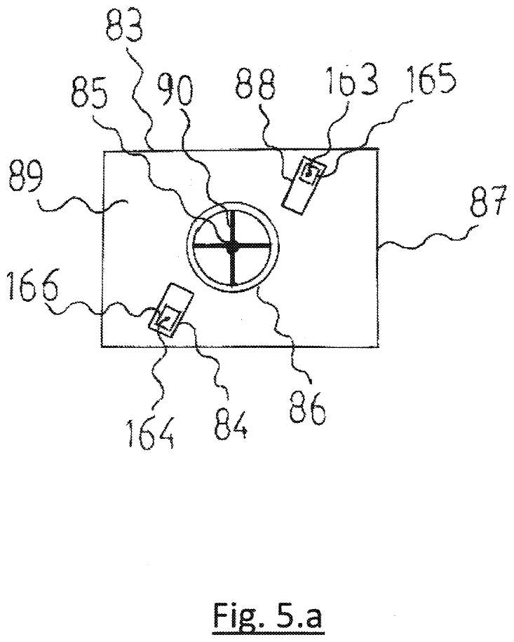

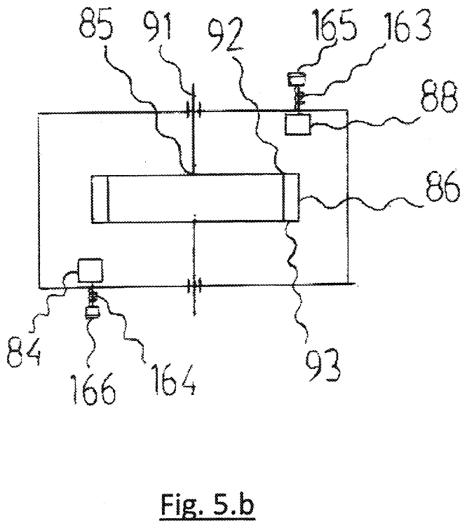

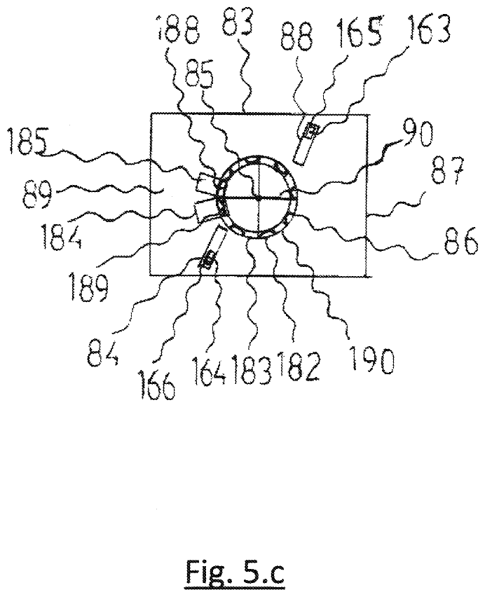

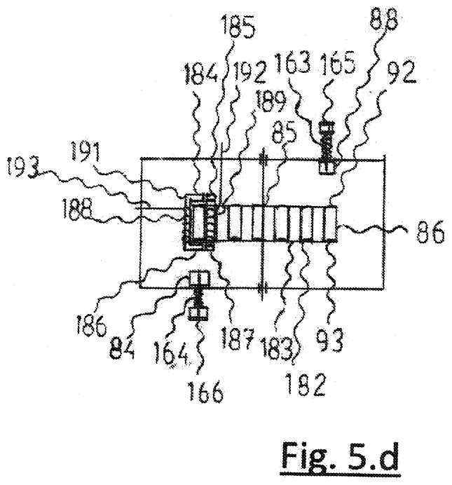

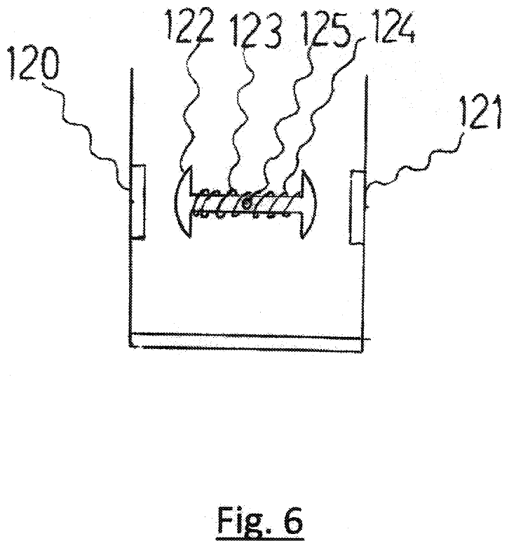

FIG. 1. a there illustrate a basic infinite auto power generation device 1 used as DC power generator and storage device made by using 3 (rechargeable) batteries that generate DC power continuously without adding power, FIG. 1.a is without the electric circuit to avoid discharge of the batteries when fully charged where:
(1) is the cathode; negative pole − of the (rechargeable) 1,2 V battery 1
(2) is the anode; positive pole + of the (rechargeable) 1,2 V battery 1
(3) is the cathode; negative pole − of the (rechargeable) 1,2 V battery 2
(4) is the anode; positive pole + of the (rechargeable) 1,2 V battery 2
(5) is the cathode; negative pole − of the (rechargeable) 1,2 V battery 3
(6) is the anode; positive pole + of the (rechargeable) 1,2 V battery 3
(7) is the cathode; negative pole − of the output for the (auto-rechargeable) battery, (the auto-rechargeable battery is the combination of battery 1 and battery 2 and battery 3 connected in parallel)
(8) is the anode; positive pole + of the output for the (auto-rechargeable) battery, (the auto-rechargeable battery is the combination of battery 1 and battery 2 and battery 3 connected in parallel), and a circuit detailed in FIG. 1.d, FIG. 1.e, FIG. 1.f acting as a switch or relais can be connected between (4)&(6) and/or (3)&(5), to avoid discharge of the 3 batteries.

### Where:

the (rechargeable) battery 1 has a voltage of 1,5 V & produce 1 A·V/h=1 W/h
the (rechargeable) battery 2 has a voltage of 1,5V & produce 0,5 A·V/h=0.5 W/h
the (rechargeable) battery 3 has a voltage of 1,5V & produce 0,25 A·V/h=0.25 W/h producing together an auto-rechargeable battery with a continuous voltage of 1,5 V that can generate at least 1 A·V/h=1 W/h continuously when all batteries 1 & 2 & 3 are fully auto-recharged, without need for external power to be recharged that need a circuit (called ‘circuit 162’) as in FIG. 1.d or FIG. 1.e or FIG. 1.f (or equivalent circuit) connected between (4)&(6) and/or (3)&(5) to avoid discharge of fully charged 3 batteries.

FIG. 1.b there illustrate an infinite auto power generation device 1 used as DC power generator and storage device made with a 7,5 V battery (containing rechargeable batteries) that generate and store DC power continuously without adding external, where:
(9) is the cathode; negative pole − of the (auto-rechargeable) battery II with 7,5 V
(10) is the anode; positive pole + of the (auto-rechargeable) battery II with 7,5 V
(11) is the cathode; negative pole − of the (rechargeable) 1,2 V battery 1
(12) is the cathode; negative pole − of the (rechargeable) 1,2 V battery 2
(13) is the cathode; negative pole − of the (rechargeable) 1,2 V battery 3
(14) is the anode; positive pole + of the (rechargeable) 1,2 V battery 1
(15) is the anode; positive pole + of the (rechargeable) 1,2 V battery 2
(16) is the anode; positive pole + of the (rechargeable) 1,2 V battery 3
(17) is the cathode; negative pole − of the (rechargeable) 1,2 V battery 4
(18) is the cathode; negative pole − of the (rechargeable) 1,2 V battery 5
(19) is the cathode; negative pole − of the (rechargeable) 1,2 V battery 6
(20) is the anode; positive pole + of the (rechargeable) 1,2 V battery 4
(21) is the anode; positive pole + of the (rechargeable) 1,2 V battery 5
(22) is the anode; positive pole + of the (rechargeable) 1,2 V battery 6
(23) is the cathode; negative pole − of the (rechargeable) 1,2 V battery 7
(24) is the cathode; negative pole − of the (rechargeable) 1,2 V battery 8
(25) is the cathode; negative pole − of the (rechargeable) 1,2 V battery 9
(26) is the anode; positive pole + of the (rechargeable) 1,2 V battery 7
(27) is the anode; positive pole + of the (rechargeable) 1,2 V battery 8
(28) is the anode; positive pole + of the (rechargeable) 1,2 V battery 9
(29) is the cathode; negative pole − of the (rechargeable) 1,2 V battery 10
(30) is the cathode; negative pole − of the (rechargeable) 1,2 V battery 11
(31) is the cathode; negative pole − of the (rechargeable) 1,2 V battery 12
(32) is the anode; positive pole + of the (rechargeable) 1,2 V battery 10
(33) is the anode; positive pole + of the (rechargeable) 1,2 V battery 11
(34) is the anode; positive pole + of the (rechargeable) 1,2 V battery 12
(35) is the cathode; negative pole − of the (rechargeable) 1,2 V battery 13
(36) is the cathode; negative pole − of the (rechargeable) 1,2 V battery 14
(37) is the cathode; negative pole − of the (rechargeable) 1,2 V battery 15
(38) is the anode; positive pole + of the (rechargeable) 1,2 V battery 13
(39) is the anode; positive pole + of the (rechargeable) 1,2 V battery 14
(40) is the anode; positive pole + of the (rechargeable) 1,2 V battery 15
(41) is the cathode; negative pole − of the (rechargeable) 1,2 V battery 16
(42) is the cathode; negative pole − of the (rechargeable) 1,2 V battery 17
(43) is the cathode; negative pole − of the (rechargeable) 1,2 V battery 18
the batteries 1 & 2 & 3 are connected in series with
the batteries 4 & 5 & 6 that are connected in series with
the batteries 7 & 8 & 9 that are connected in series with
the batteries 10 & 11 & 12 that are connected in series with
the batteries 13 & 14 & 15 that are connected in series with
the batteries 16 & 17 & 18
producing together a basic auto-rechargeable battery with:
a voltage of 7,5 V that can generate of at least 1 A·V/h=1 Watt/h=1 W/h continuously and that can recharge itself without need for external power AND that will be discharged after being fully charged, unless adding 6 ‘circuits 162’ (or equivalent circuit) to avoid discharge.

FIG. 1.c illustrate a, an infinite auto power generation device 1 used as DC power generator and storage device in a (auto-rechargeable) 7,5 V batteries made with the same (rechargeable) batteries as in FIG. 1.b but connected differently & with 1 of the 3 circuit called ‘Circuit 162’ to avoid discharge of the fully recharged 7,5 V battery build when:
the (rechargeable)batteries 1 & 4 & 7 & 10 & 13 & 16 are connected in series forming an auto-rechargeable battery of 7,5 V with a power of 1 W/h that has to be recharged by:
the (rechargeable) batteries 2 & 5 & 8 & 11& 14 & 17 connected in series forming 1 of
   the (rechargeable) battery of 12 V with a power of 0.5 W/h and by
the (rechargeable) batteries 3 & 6 & 9 & 12 & 15 & 18 connected in series forming 1 (rechargeable) battery of 7,5 V with a power of 0.25 W/h

### AND

when,
the batteries 2 & 5 & 8 & 11& 14 & 17 are connected in parallel with the the batteries 3 & 6 & 9 & 12 & 15 & 18 by having:
the pole − (12) of battery 2 connected to the pole − (13) of battery 3 and
the pole + (46) of battery 17 connected to the pole + (450 of battery 18 (162) is a manual relais switched off if 7,5 V battery 1&4 & 7 & 10 &13 716 is fully charged
   the batteries 1 & 4 & 7 & 10 & 13 & 16 are connected in parallel with
   the batteries 2 & 5 & 8 & 11& 14 & 17 &
   the batteries 3 & 6 & 9 & 12 & 15 & 18
      with pole − (12)&(13) of battery 2 & 3 connected to pole − (11) of the battery 1
      AND pole + (45) & (46) of batteries 17 & 18 are connected to 1 of the 3 circuits of ‘circuit 162’ that switches on/off the connection with pole + (44) of the 7,5 V battery 1 W/h when the voltage of the batteries 1 & 4 & 7 & 10 & 13 & 16 is below/above full charged ˜7,5 V.

FIG. 1.d show 1 of the 3 circuits called ‘circuit 162’ for the auto-rechargeable battery of 7,5 V with 1 W/h, (or for any other battery voltage or power storage), with a relais, allowing to stop recharging the battery with 7,5 V and 1 W/h (when fully charged) and to allow it being maintained recharged automatically (when partly discharged).

The relais (168) & (169) & (170) &(171) is activated by a simple electric circuit (that uses a zener diode 167 of ^{˜}7,2 V, as an example, with a transistor (166), relais, and resistor (165) to switch on/off the connection between the anode (164)=anodes (45)&(46) (FIG. 1.c) of the 2 other batteries recharging the anode (163)=anode (44) (FIG. 1.c) of 7,5 V; 1 W/h battery 1&4&7&10&13&16 to recharge.

When (181) is connected to pole − (11)&(12)&(13) (FIG. 1.c), this a low continuous auto recharging and avoid discharge of the 7,5 V &1 W/h battery 1&4&7&10&13&16) to recharge.

FIG. 1.e Show how the circuit with 3 inverted diodes in parallel (174) & (175) &(176) let more current go from the anodes (172) (FIG. 1.e)=(45)&(46) (FIG. 1.c) of the batteries with the highest power go to the anode (173) (FIG. 1.e)=(44) (FIG. 1.c) of the battery with lower power, that has to be charged to prevent the 7,5 V battery 1 & 4 & 7 & 10 & 13 & 16 with 1 W/h (that has to be charged) from discharging. The circuit in FIG. 1.e has no mechanical parts and can have more than 2 diodes in both direction of the current.

FIG. 1.f shows a circuit similar to FIG. 1.e, but it uses 2 inverted diodes, 1 diode with its anode connected to the anode (177) (FIG. 1.f)=(45)&(46) (FIG. 1.c) pole + of the 2 rechargeable 7,5 V batteries charging the anode (178) (FIG. 1.f)=(44) (FIG. 1.c) of pole b+ of 7,5 V & 1 W/h battery 1& 4 & 7 & 10 & 13 &16 that has to be charged, this is possible because each diode lowers the incoming voltage differently.

For example: a diode (179) can lower the voltage by 0,35 V, while the other diode (180) can lower the incoming Voltage by 0,37 V this let the current go from the pole + (177) (FIG. 1.f)=(45) & (46) (FIG. 1.c) to pole + (178)(FIG. 1.f)=(44) (FIG. 1.c), preventing the 7,5 V (1 W/h) battery 1&4&7&10&13&16 discharging from its pole + (44) (FIG. 1.c) when charged. this circuit use no mechanical parts.

The schema in FIG. 1.b can lead batteries being overcharged & gradually discharging without the use of 6 relais, or 6 circuits similar to ‘circuit 162’

FIG. 1.d and FIG. 1.e and FIG. 1.f show 3 equivalent circuits called ‘circuit 162’ (as examples of circuits) replacing relais 162 to avoid discharge of batteries in FIG. 1.c,

The circuits in FIG. 1.e & in FIG. 1.f have no mechanical parts, and are 2 of the 3 circuits called ‘circuit 162’ meant to replace and improve the manual relais 162.

FIG. 1.g illustrate an infinite auto power generation device 3 used as a DC generator and storage device in a Charger device to charge or recharge (re-chargeable) batteries or capacitors, . . . , that does not need external power to charge again and again, . . . (re-chargeable) batteries, (storage) capacitors, . . . when using this auto recharging charger for batteries and/or capacitors where:
(94) is the cathode; negative pole − of the (rechargeable) 1,2 V battery 1
(96) is the anode; positive pole + of the (rechargeable) 1,2 V battery 1
(95) is the cathode; negative pole − of the (rechargeable) 1,2 V battery 2
(97) is the anode; positive pole + of the (rechargeable) 1,2 V battery 2
AND
(98) is the negative pole − output of the infinite auto power generation charger connected to the cathode; negative − pole of the 1,2 V (rechargeable) battery III that has to be recharged.
(99) is the positive pole + output of the infinite auto power generation charger connected to the anode; positive + pole of the 1,2 V (rechargeable) battery III to recharge, where; (for example):
battery 1 has a voltage of 1,2 V that can generate 0,25 A·V/h=0.25 W/h battery 2 has a voltage of 1,2 V that can generate 0,50 A·V/h=0,50 W/h and battery III is the 1,2 V (rechargeable) battery with 1 W/h to recharge: Battery III has a voltage of 1,2 V and can generate at least a 1 A·V/h=1 W/h when fully charged.

Battery III, with 1,2 V and 1 W/h has to be disconnected from the charger when fully charged to avoid is being discharged.

Battery III can have a higher power than 1 Watt/h, for example 5 W/h, or more while battery 1 and battery 2 can keep their respective voltage of 1,2 V and 0.25 W/h and 0,50 W/h. Any of the circuits called ‘ circuit 162’ shown in FIG. 1.d or FIG. 1.e or FIG. 1.f can be used to avoid discharge of the battery III to recharge while it is recharging by the charger. A relais (168) & (169) & (170) &(171) with Zener diode (167), and a transistor (166) and/or a circuit controlling the voltage from ˜1 V to >12V; as examples) for battery III can be added to the infinite auto power generation charger to switch off the connection between the cathode (98) and/or anode (99) of the infinite auto power generation charger and the cathode and/or anode of rechargeable battery III to recharge.

This infinite auto power generation charger can charge in theory an infinite number of empty batteries of 7,5V, if battery 1 and Battery 2 have a voltage of 7,5 V and a power that is different from the battery III (that is the battery to be recharged) and if battery III has also 7,5 V and if all batteries 1 & 2 & III are all functional.

The higher the storage power (and voltage) of battery 1 and battery 2 the faster the recharge of battery III.

Both battery 1 and battery 2 and battery III should have all the same Voltage, for example 1,5 V, or 12 V, or 100 V, or any other higher voltage. This schema in FIG. 1.g of an infinite auto power generation device used as a charger with 2 rechargeable batteries is an example; that can be build with more than 2 batteries with the same voltage (that can be >1 V; above 1 volt) with different (any other) storage powers connected in parallel to function faster as Charger of (rechargeable)batteries and/or capacitors or other electric power units from other products.

FIG. 1.h there illustrate an infinite auto power generation device 2 used as 2,4 KW/h DC power generator of 24 V & 100 A power storage device made with 2 batteries of 12 V, 60 A & 2 batteries 12V, 40 A (or 2,4 . . . batteries and 2,4 . . . capacitors with other voltage & power) to generate and store DC power continuously without adding external, where: (193) is the anode, pole + and (202) is the cathode; pole − of 12 V, 60 A battery W (195) is the anode, pole + and (196) is the cathode, pole − of 12 V, 60 A battery X (198) is the anode, pole + and (199) is the cathode, pole − of 12 V, 40 A battery Y (200) is the anode, pole + and (201) is the cathode, pole − of 12 V, 40 A battery Z (208) is the anode, pole + and (207) is the cathode, pole − of 2,4 KW/h battery (I.A.P.G.D). batteries Y & Z can be replaced by storage capacitors & battery W, X, Y, Z can have other voltages (V), power (A, W/h). (203) & (204) are 2 (schottky) diodes. (205) & (206) are 2 manual switches to avoid discharge that be replaced by circuit in FIG. 1.d, FIG. 1.e, FIG. 1.f or other similar circuit.

Battery W & X are connected in series and battery Y & Z are connected in series AND battery W & X are connected in paralleled with battery Y & Z. Both O V (GRD) of battery W & X and Y & Z are connoted together to 2 diodes; with 1 diode's cathode to pole − of battery Y & Z, 1 diode's anode to pole + of battery W & X 0.1 switch connects each diode.

FIG. 2.a shows an infinite auto power generation device 5 used a AC power generator
(47) is one of the pole of the (ceramic . . . ) capacitor 1
(50) is the other pole of the (ceramic . . . ) capacitor 1
(48) is one of the pole of the (ceramic . . . ) capacitor 2
(51) is the other pole of the (ceramic . . . ) capacitor 2
(49) is one of the pole of the (ceramic . . . ) capacitor 3
(52) is the other pole of the (ceramic . . . ) capacitor 3
(53) is the output pole of the infinite auto power generation device generating AC power with capacitors, that produce an (AC) alternating (high or low) frequency current continuously without adding any external power
(54) is the other output pole of the infinite auto power generation device generating power with capacitors that produce AC power; (high or low) frequency alternating current continuously without adding any external power.

As an example:
3 ceramic capacitors can be used
Capacitor 1 has a voltage of 100 V and a capacity of 100 pF
Capacitor 2 has a voltage of 100 V and a capacity of 1000 pF
Capacitor 3 has a voltage of 100 V and a capacity of 10 000 pF

Capacitors with low value (pF) produce (very) high frequency AC voltage (that can be high voltage and producing continuously and increasingly without adding external power ionized air, without need for initial power) while capacitors with a high value (MKP, . . . ) produces low frequency AC power if the 3 or more capacitors are in/on a HV insulator.

The greater the power (high) capacity in Farad (V) and high voltage in (V) of the 3 or more capacitors the greater the electrical power generated, but the frequency & voltage is higher with lower capacities. These 3 or more capacitors in parallel, produce AC power (ionized air, electron, . . . ) continuously without adding any external power.

With 3 capacitors with a voltage of 220V connected in parallel and capacities of (for example) 50 MKP, 25 MKP, 100 MKP, more AC power can be produced, in theory: 0,0001*44 000=4 W/h max continuously without adding external power when these 3 capacitors are kept insulated by a HV anti static insulator around them.

This AC power produced by at least 3 capacitors connected in parallel can be amplified by 1 or more new type of transformer & circuit as described in FIG. 3.b.

As with batteries charger, all capacitors in this infinite auto power generation device used as AC generator should have similar voltage (V) and at least 2 or 3 different capacities (F).

FIG. 2.b shows an infinite auto power generation device 4 used as DC power generator and storage device made with (high and very or ultra high) storage, electrolytic, polarized capacitors, . . . generating DC power continuously without adding external power, where:
(55) is the negative pole − of the (storage, electrolytic, . . . ) capacitor 1
(58) is the positive pole + of the (storage, electrolytic, . . . ) capacitor 1
(56) is the negative pole − of the (storage, electrolytic, . . . ) capacitor 2
(59) is the positive pole + of the (storage, electrolytic, . . . ) capacitor 2
(57) is the negative pole − of the (storage, electrolytic, . . . ) capacitor 3
(60) is the positive pole + of the (storage, electrolytic, . . . ) capacitor 3
(61) is the negative pole − & − output of the continuous auto re-charging capacitor, that produce a DC current continuously without adding an external power.
(62) is the positive pole + and + output of the continuous auto re-charging capacitor, that produce a DC current continuously without adding an external power.

As with batteries, all capacitors of this infinite auto power generation device should have the same voltage (V) and at least have 2 or 3 different capacities (F).

where; as an example the electrolytic
Capacitor 1 has a voltage of 10V and a capacity of 10 uF
Capacitor 2 has a voltage of 10V and a capacity of 100 uF
Capacitor 3 has a voltage of 10V and a capacity of 1000 uF

This infinite auto power generation device made with (high) storage, electrolytic, ultra

Polarized capacitors, . . . that generate DC power continuously without external power can generate about:
0,001*(10*2)=0.1 Watt, and must have a circuit as in FIG. 1.d, FIG. 1.e, FIG. 1.f between (59) & (60) (FIG. 2.b) to avoid discharge.

(The capacitor's leak current limit the power generated continuously). With 3 capacitors with a voltage of 220V and for example 50 uF, 25 uF, 100 uf more DC power can be produced continuously without adding external power, in theory: 0,0001*44 000=4 W max, when these 3 capacitors are kept insulated with a HV (anti-static) insulator.

FIG. 2.c illustrate an infinite auto power generation device 4 used as DC power generator and storage device, (made with polarized capacitors) and as Charger generating DC power continuously without adding any external power when charging or recharging capacitor where:
(102) is the negative pole − of the (storage, electrolytic, . . . ) capacitor 1
(100) is the positive pole + of the (storage, electrolytic, . . . ) capacitor 1
(103) is the negative pole − of the (storage, electrolytic, . . . ) capacitor 2
(101) is the positive pole + of the (storage, electrolytic, . . . ) capacitor 2
(104) is connected to the positive pole + of the capacitor V that has to be recharged and is the positive pole, anode + of the auto recharging charger.
(105) is connected to the negative pole − of the capacitor V that has to be recharged and is the negative pole, cathode − of the auto recharging charger,
   where; as an example the 2 electrolytic capacitors acting as charger are:
Capacitor 1 with a voltage of 10V and a capacity of 10 uF
Capacitor 2 with a voltage of 10V and a capacity of 100 uF
   and the capacitor V that has to be charged (or recharged), for example is
Capacitor V with a voltage of 10V and a capacity of 1000 uF

As with batteries charger, all capacitors of the charger & the capacitor to charge should have the same voltage (V) and at least have 2 or 3 different capacities (F).

As with battery charger, the capacitor V to recharge, must be disconnected from the charger in FIG. 2.c as soon as it is recharged to avoid discharging. A circuit equivalent to an automatic switch, or relais such as 1 of the 3 circuits detailed in FIG. 1.d, FIG. 1.e, FIG. 1.f can be connected between (104) in FIG. 2.c & the anode of capacitor V to disconnect it from charger.

As an example, this new continuous DC auto power generation charger made with (high) storage electrolytic, polarized capacitors, ultra capacitors, . . . that does not need external power can generate continuously without adding external power at least about 0,001*(10*2)=0.1 Watt, (to recharge a capacitor). This charger and capacitor while recharging have to be kept on/in a HV insulator (HV=high voltage) (anti-static insulator). (Usually the capacitor's leak current limit the power generated continuously).

This charger needs a least 1 or 2 capacitors with different capacities (F) and similar voltage, depending whether the capacitor to charge has a different capacity than the 2 capacitors in the Charger and all 3 capacitors should have about the same voltage (V).

FIG. 2.d shows an infinite power generation device 12 used as both AC and DC power HV generator made with a: disymetric capacitor generating power continuously without adding any external power, where:
(126) is the electrode with the largest size; the negatively − charged cathode that can be made of a metal foil, metal conductor, . . .
(130) is the wire connected to the largest electrode, the cathode with negative electric pole − that can be made of a metal foil,
(127) is the electrode with the smallest size and is the positively + charged anode that can be of a metal foil . . .
(129) is the wire connected to the smallest electrode, the anode with the positive electric pole +
(128) is the High Voltage (anti-static) insulator that can be air, paper with oil, or paraffine, . . . (as examples)

This infinite auto power generation device generating DC (and AC) power is a disymetric capacitors with two electrodes (126) & (127) with different sizes separated by a HV (high voltage) anti-static insulator (128) generating both DC and an AC power simultaneously, and continuously without adding any external power if kept surrounded and insulated by HV insulator (for example paper with oil, parafine, mica, . . . ) If kept insulated in a case, or on/with an HV insulator, this disymetric capacitor generates continuously without external power: increasing quantity of negative charge − on the electrode with the largest surface and volume, forming the cathode (126) connected to the wire (130) AND increasing positive charge + on the smallest electrode (127);
forming the anode (127).

This dissymmetry in the size of the 2 electrodes (126) & (127) and dissymmetry in the quantity of electric charges in the 2 electrode of this disymetric capacitor produces DC power (and AC power) continuously (in the form of ionized air if the capacity value of the disymetric capacitors is in ˜pF; about a few cm2 in surface with HV insulator less ˜<0.1 mm thick.

This is achieved more easily by keeping completely insulated the disymetric capacitor with a (very high voltage) HV anti-static insulator and in a case and by using a (very) High Voltage (HV) insulator between the 2 electrodes with different sizes; for example paper in case in oil, paraffine, mica, glass, quartz, . . . that surround the disymetric capacitor.

The higher the value of the capacity (F) of the disymetric capacitor (electrodes with very different large surface, volume), the lower the frequency, and the greater the power generated by the disymetric capacitor

The greater the difference in surface and volume of the 2 electrodes; the greater the DC voltage produced in the disymetric capacitor that generates both AC and DC current & voltage from this infinite auto power generation device. Both the cathode and anode of this disymetric capacitor can be covered/surrounded with a HV (high voltage) anti-static insulator.

FIG. 2.e shows, an infinite auto generation power device 14 used as ionic thrust power generator and as an electron/ion beam generator made with a modified disymetric capacitor with at least 1 hole producing continuously a thrust force without adding any external power in the form of an electrons (or ions) beam, where:
(131) is the cathode; charged negatively − and the electrode with the largest size and with at least one (small) hole in the negative − electrode that can be of a metal foil . . . (this cathode can be connected to (a) wire if necessary and covered with a HV (high voltage) anti-static insulator that has a hole facing the cathode's hole)
(133) is the anode charged positively + and the electrode with the smallest size and with at least one (small) hole in the electrode that can be a metal foil, . . . (this anode can be connected to (a) wire if necessary and covered with a HV (high voltage) anti-static insulator that has a hole facing the anode's hole)
(132) is the high voltage (HV) (anti-static) insulator with at least one (small) hole
(134) are the 2 holes in the 2 electrodes and the hole in the HV insulator that are facing each other and forming together at least one (small) hole (in this example), where the ions and/or electrons beam is generated by the negative − charges on the largest electrode (131) that are going, and attracted, pushed by the positive + charged smallest electrode (133) and going through the hole(s) in the 2 electrodes and in the hole of the (thin) HV insulator (132) of the disymetric capacitor, these 3 holes form one single hole (134) in the disymetric capacitor with disymetric sized electrodes, and can be made for example: by using aluminium foils of different dimensions on each side of the paper with oil or paraffine, or mica, . . . and where a hole is made, and by avoiding any contact between the 2 foils with different sizes and by keeping this device insulated by a High voltage (HV) insulator allowing the free flow of electrons/ions from the cathode − to the anode +, (for example by using a large paper with paraffine, or other high voltage (HV) insulator to hold, and/or surround this infinite auto power generation device made from a disymetric capacitor with hole(s).

Two Pieces of paper of different size can also be used as electrodes of different size and cellular (plastic) tape can also be used as an insulator between the 2 pieces of paper where one or more (small) hole(s) is/are made in the 2 pieces of paper & in the tape, the electron/ion beam creation is slower but continuously increasing.

FIG. 2.f shows; an infinite auto power generation device 16 made with insulated wires and HV (anti-static) insulator used as High voltage (HV) generator of DC & AC producing power continuously without adding external power where:
(135) is (136) are the 2 insulated extremities of 1 of the 2 conductors (wire; conductor A)
(138) and (139) are the 2 other non insulated extremities of the other conductor B
(140) is the case in paper with paraffine, oil . . .
(137) is the (very) (HV) (anti-static) insulator; paper with paraffine, oil, PET, . . . with both insulated conductors (with similar or different length and/or thickness) are held together with a (thin) HV anti static insulator (137) between them, and one of the insulated extremity of one insulated conductor B is being torsaded, or spinned through a part of the length of the extremity of the other conductor A.

While both other extremities (138) & (135) of the 2 insulated conductors A & B are not insulated & emit continuously increasing AC field, voltage & current at a high and/or frequency, when:
a HV (anti static) insulator (137) is between the 2 insulated wires that are held together (and forming a disymetric capacitor)
and when these 2 insulated conductors held together with a HV insulator between them are kept completely insulated by a HV (anti-static) insulator, for example in a case
(140) with paper with paraffine . . . .

If the 2 insulated conductors are different in size or length, and held together with a HV insulator between them, then the longest and/or thickest insulated conductor extremity will have an oscillating negative − charged voltage & the smallest/shortest insulated conductor will have a positive + oscillating voltage.

A series of such (disymetric) capacitors (insulated conductors held together with a a HV insulator between the 2 insulated conductors) can be connected in series s to increase the DC and/or AC voltage, while all disymetric capacitors are kept insulated in a case with a HV insulator (for example; a case with paraffine, oil) that surround all disymetric capacitors FIG. 7.a shows; an infinite auto power generation device 17 made with at least 2 or 3 similar electric (rechargeable) batteries of at least 1,2 Volt and any power storage, as an example the − pole of battery 1 (208) is connected to both cathodes of at least 1 or 2 diodes (210) & (211) in parallel and to the − pole of an (electrolytic) capacitor of 1000 uF (212) (with a voltage superior than battery 1 and battery 2) and to the emitter of an NPN transistor (BC547), (213), while the + pole of battery 2 (209) is connected to the anodes of at least 1 or 2 diodes (210) & (211) in parallel and to the + pole of the electrolytic capacitor of 1000 uF (212) and to the collector of the NPN transistor (BC547) (213), and the base of the transistor (312) is connected to a resistor (47K Ohms) (214) and the other extremity of the resistor is connected to the + pole of battery 2 (209). The + pole of battery 1 (208) is connected to the + pole of battery 3 (207) to charge and the − pole of battery 2 (209) is connected to the − pole of battery 3 (207) to charge.

Both (rechargeable) Battery 1 (208) and battery 2 (209) must be charged initially for the electric (rechargeable) battery 3 (207) to be recharged. If only battery 1 (208) and battery 2 (209) are used the circuit can act as a battery charger, and battery 3 (207) can be removed or replaced when charged, by an empty battery to be recharged. The batteries 1 & 2 & 3 (207) or (208) or (209) can made of many batteries in parallel or series to be recharged, if they combined power is about the same power and the same voltage as battery 1 and battery 2. Battery 1 (208) and battery 2 (209) can each be made of a few batteries in parallel or on series s with similar power and voltage. If at least 3 batteries are used this circuit can act as an independent power generator, when battery 3 is recharged.

FIG. 7.b shows; an infinite auto power generation device 18, has at least 2 HV insulated (219) anti-parallel diodes (215)&(216); anode has a ring (217), cathode has a needle point (218).

FIG. 2.g shows how an other structure of an infinite auto power generation device 13 made used as high or low frequency transformer (that have a capacity) and as AC& DC power generator made with at least 2 insulated wire separated by a HV (anti-static) insulator generating and transforming electro (-static) power continuously without adding external power, that is build with: (141) & (142) are 2 conductors (with similar length and thickness), (143) & (149) is the (HV) high voltage (anti static) insulator, (144) & (145) are the extremities of the insulated conductor (141), (146) & (147) are the extremities of the insulated conductor (142)
(148) is the case made with paper containing paraffine as a HV insulator (as example) The conductors (wires, . . . ) (141) & (142) (with similar length and thickness) that are held together at the middle of their length with between them a (very) thin and (very) high voltage (HV) anti static insulator (143) in the middle of their length.

(For example: the middle of the length of both insulated conductors is separated by a HV insulated between them and torsaded, or glued, or spinned through part of their length with each other). The 2 insulated wires (141) & (142) that are held together by being (for example spinned together with a HV insulator (143)&(149) between the 2 spinned conductors in the middles of their length) are forming a transformer (and capacitor), that can be used to produce and increased voltage and/or current when kept completely insulated by a HV high voltage insulator, (for example in a case (148) with paper filled with paraffine . . . ). If one of the 2 insulated conductors (141) or (142) are different in size or length, and held together with between them a HV insulator, then the longest and/or largest insulated conductor will produce an increased or decreased oscillating negative − charged voltage, while the smallest or shortest insulated conductor will produce an increased or decreased oscillating positive + voltage depending on the number of spire in the conductor (141) and conductor (142).

The 2 insulated conductors (141) & (142) (that are spinned against each other with a HV insulator (143) between them that separate both insulated conductors) have 2 extremities that can be the input (144) & (145) and 2 other extremities that can be the output (146) & (147) of the transformer that produce an increasing AC voltage and current at a high or low frequency when kept completely insulated in a case (148) with a HV insulator.

A series of such transformers shown in FIG. 2.g (; insulated conductors held together with between a HV insulator) can be added, connected in parallel or in loop, or in series to increase or decrease the AC and DC voltage and/or current that can be produced continuously without adding an external power. A number of this device can be connected in parallel and/or series s can produce very high AC voltage (HV) and very high frequency electro-static fields, current, voltage that generate ionized air.

FIG. 2.h shows an infinite auto power generation device 15 used as HV AC& DC power generator and as HV electro-static power amplifier made with 4 insulated conductors and 3 HV (anti static) insulator in a HV insulated case, that amplify and generate AC &C electrostatic power continuously without adding external power in the form of an electrons/(or ion) beam(s) device that can be used for ionizing air, gasses or for space engine using ion beam or as HV generator, to charge High voltage capacitor . . . build with at least 4 (insulated) conductors (161) & (150) & (152) & (154) (with different length and/or thickness) that are held together at one the end of their length (of each 4 insulated conductors) with between them a (very) thin high voltage (HV) anti-static insulators (158) & (151) & (153).
conductor (161) is longer and/or thicker than conductor (150),
conductor (150) is longer and/or thicker than conductor (152)
conductor (152) is longer and/or thicker than conductor (154),

The (insulated) conductor (150) is spinned around the HV (anti-static) insulator (158) that covers one extremity of the (insulated) conductor (161),

The (insulated) conductor (152) is spinned around the HV anti static insulator (151) that covers one extremity of (insulated) conductor (150),

The (insulated) conductor (154) is spinned around the HV (anti static) insulator (153) that covers one extremity of the (insulated) conductor (152)

These 4 conductors form 3 disymetric capacitors that each invert and increase the charge polarity:

If conductor (161) has initially a negative (−) charge then the conductor (150) has an increased positive (+) charge & then conductor (152) has an increased negative (−) charge that is higher than the negative charge (−) on conductor (161) and then conductor (154) has a positive (+) charge that is higher than the positive (+) charge on conductor (150).

When conductor (152) (with an increased negative − charge) is connected to conductor (161) (with a negative − charge) it creates a loop that increase continuously even more the negative − charge on conductor (161) and then again on conductor (152), that further increase the positive + charge on conductors (154) and (155) and on the ring (156).

Conductor (155) has then a very high positive + charge that is connected to a ring (156) (as an example) acting as anode +. The high negative − charges emitted by the point of the needle (159) (as an example) that is connected to conductor (161) are attracted and go through the positively charged ring (156) (that is connected to the positively charged conductor (155), creating a beam of negatively charged particles, in air, vacuum, . . . .

The conductors (161) & (150) & (152) that create 2 disymetric capacitors in a loop is here an example, more disymetric capacitors can be used in loop for example 4 or 6 or more to amplify − charges in loops or 3 or 5 or more to increase + charges in a loops, this increase even further the voltage and intensity of the devices, and power, beam, . . . or HV generator.

This device has no mechanical parts and other similar devices can be added and connected in series s (pole − to pole pole +) or parallel to create more powerful electron beam, or charged particles beam continuously without need for external power and can, be used to generate thrust for engines used in space, vacuum, or to ionize air, gases, plasmas . . . or to generate more high voltage (HV) power continuously without adding external power.

To function with an optimal result this device needs to be in a case or box (157) that is filled with a very good (anti-static) insulator (160) (for example: with paraffine, oil, . . . )

FIG. 3.a illustrate an infinite auto power generation device 6 used as AC power generator and AC power amplifier made with at least 3 or 4 usual transformers that have an internal capacity (behave also as capacitors) and that may need an initial AC external power initially but not later, where:
(110) is the secondary (output) coil of transformer 1
(111) is the core of transformer 1
(112) is the primary (input) coil of transformer 1
(113) is the secondary (output) coil of transformer 2
(114) is the core of transformer 2
(115) is the primary (input) coil of transformer 2
(116) is the secondary (output) coil of transformer 3
(117) is the core of transformer 3
(118) is the primary (input) coil of transformer 3
(108) & (109) are the outputs of the 3 secondary (output) coils of transformers 1 & 2 & 3 that are connected in parallel
(106) & (107) are the inputs of the primary (input) coils of transformers 1 & 2 & 3 that are connected in parallel, where:
the secondary (output) coil of transformer 1 is connected in parallel to the secondary (output) coil of transformer 2 and to the secondary (output) coil of transformer 3 AND
the primary (input) coil of transformer 1 are connected in parallel with the primary (input) coil of transformer 2 and the primary (input) coil of transformer 3 As an example:
transformer 1 has an output (secondary) voltage of 12 V and a power of 6 W/h
transformer 2 has an output (secondary) voltage of 12 V and a power of 3 W/h
transformer 3 has an output (secondary) voltage of 12 V and a power of 1 W/h
AND
transformer 1 has an input (primary) voltage of 220V and a power of 6 W/h
transformer 2 has an input (primary) voltage of 220V and a power of 3 W/h
transformer 3 has an input (primary) voltage of 220 V and a power of 1 W/h

As an example:

The pole outputs (108) & (109) of the continuous auto (re)charging transformer that produce an (AC) alternating (high) frequency current can be transformed again by connecting the secondary output (108) and (109) to the input of a 4th transformer: transformer 4 has an input (primary) voltage of 12 V and a power of ˜10 W transformer 4 has an output (secondary) voltage of 220V and a power of ˜10 W (108) & (109) outputs are connected in phase or anti phase (90 degree+90 degree=180 degree) to the input of transformer 4 and the output of transformer 4 is connected to a circuit made of diodes (for example) AC current go only to the inputs (106) & (107) of the 3 transformers connected in parallel.

The principle used with these 3 (or 4) transformers is similar to the principle used with (re-chargeable) batteries, capacitors, . . . for DC power shown in FIG. 1.a but it is adapted to AC power by using transformers with different output power but same voltage that use the same input voltage but different input powers for each 3 or 4 transformers.

The same principle, circuits can be used with 4, 5 or more usual transformer.

FIG. 3. b illustrate an infinite auto power generation device 7 used as AC power generator and AC power amplifier made with a combination of at least 2 new model/type of transformers that amplify more an incoming alternative (AC) current (than usual transformer) and that are connected in a loop to produce AC power continuously without need for external power, where:
(26) & (27) are the input of the primary transformer A
(28) & (29) are the output of the primary transformer A
(30) & (31) are the input of the secondary transformer B
(32) & (33) are the output of the secondary transformer B
(34) is the coil of the input of the primary transformer A (made with insulated magnetic alloy wire for example; insulated silicon steel [iron (95%) with silicium (Si ˜5%, Fe, 95%)] wire, or insulated iron (30%-70%)-nickel (70%-30%) alloy wire . . . (that amplifies the alternating magnetic field in/around the insulated magnetic alloy wire)
(35) is the coil of the output of primary transformer A made with an insulated non magnetic wire (for example; insulated copper wire).
(36) is the input coil of the secondary transformer B (made of an insulated magnetic alloy wire(s) for examples; insulated silicon steel wire, or insulated iron-nickel alloy wire . . . (that amplifies alternating magnetic field around the insulated magnetic alloy wire)
(37) is the output coil of the secondary transformer B made of copper or other non magnetic alloys.
(38) is the core (made in silicon steel, ferrite, . . . ) of the primary transformer A
(39) is the core (made silicon steel, ferrite, . . . ) of the secondary transformer B.

These 2 new model/type of transformers A & B; amplify the AC current from the input (26) and (27) by using an insulated magnetic alloys wire in the input coils (34) of the primary transformer A and in the input coil (36) of the secondary transformer B.

The insulated magnetic alloy wires forming the coils (34) and (36) can be for example insulated silicon steel wire, or insulated iron-nickel alloy wire, . . . (instead of insulated copper wire).

These coils made with insulated silicon steel wire, . . . are:
in the input coils (34) of the primary transformer A and in the input coil (36) of the secondary transformer B, that amplify more the magnetic field produced by the AC current from the input primary coils (34)& (36) in the cores (38) & (39) and again in the output coils (35) &(37) of the 2 transformers A & B; this results in an amplified alternating inductive AC current and AC power in the output coils made of copper (35) & (37) of the 2 new type of transformers A & B, that is available in the outputs (28) & (29) of coils (35) made with insulated copper wire in the primary transformer A and in the outputs (32) &
(33) of the output coil (37) of the secondary transformer B.

The amplified power output from transformer A is amplified again in transformer B, and can be amplified further again with more transformers designed as transformer A & B connected as shown in FIG. 3.b.

Together (both transformer A and transformer B) invert the phase of the input current by 180 degrees. The phase of the current outputs (32) & (33) are inverted by 90 degrees in transformer B and again by 90 degrees in the outputs (28) & (29) of transformer A; resulting in a inversion of phase by 180 degrees by the 2 new type of transformer A & B.

The output (32) & (33) of secondary transformer B can be connected in a loop in such a way (by a circuit of diodes or other electric circuit,) to the input (26) & (27) of primary transformer A again; to amplify more the outputs of secondary transformer A& B. Three or 4 of these new type of transformers can also be used in the circuit in FIG. 3.a.

FIG. 4.a illustrate an infinite auto power generation device 8 used as AC power generator and charger made with 1 coil, at least 2 diodes, a magnet in a the form of a rod or bar, and a HV (anti static) insulator used a an AC power generator, where
(40) is the magnet
(41) is the HV anti-static insulator
(42) & (43) are the outputs of the coil
(44) is the coil,
(45) & (46) are the 2 (fast switching)diodes
(47) & (48) are the HV (anti static) insulator between the magnet & the coil that insulate also the diodes.

The insulated magnet (40) shaped in a bar (or rod) form, generates a vibrating (AC) current indefinitely continuously by connecting both side of the longest extremity of the magnet (40) to 2 insulated inverted diodes (45) and (46) in parallel and by putting a very (thin) High Voltage (HV) anti-static insulator (41) between the very narrow space separating the vibrating magnet and the coil.

The insulated magnet contract and de-contract it self by using the magneto contraction & de-contraction caused by the very low current AC voltage between both extremities of the large magnet (preferably made of metals, alloys, . . . ) that the 2 (or more) insulated diodes (or zener diodes & diodes) short circuit repeatedly, when the insulated magnet (40) diodes are kept insulated with a HV anti-static insulator (41), and (47), and (48).

The magnet that vibrates in its longest section generates a vibrating magnetic field around the magnet (40) that produce a vibrating, and/or alternating current in the output (42) and (43) of coil (44).

The coil (44) should have the adequate impedance to resonate with the frequency of the vibrating magnet; to increase the inductive current in the coil (44), this means that the coil (44) should have the right dimensions, numbers of spires, . . . .

The AC power produced continuously without adding external power can be increased by connecting it to a new type of transformer as detailed in FIG. 3.b or converted to DC power with diodes. Zener diode(s) instead of 2 diodes (45) & (46) give a pulsating DC power that is produced continuously without adding external power.

FIG. 4.b illustrate a 2sd structure of an infinite auto power generation device 8 used as AC power generator and AC Charger made with a magnet in a tube form, a coil with a core made with a magnetic alloy (ferrite, silicon steel, iron-nickel alloy, . . . ) and a HV (anti static) insulator, 2 diodes, where:
(52) is the magnet in the form of a tube
(50) & (53) & (54) & (55) is the HV antistatic insulator
(51) is the coil,
(49) is is the core of the coil,
(56) & (57) are the 2 (fast switching) diodes
(58) & (59) are the outputs of the coil producing AC current and AC power.

The core (49) is insulated from the coil (51) with a thin High Voltage (HV) anti static insulator and is placed, held inside a (metallic, . . . ) magnet (52) with a form of a tube that is also insulated with a HV (anti-static) insulators (53), (54),(55).

The insulated magnet (52) vibrates and generates an alternating (AC) current indefinitely in the coil (51) continuously by connecting both side of the longest extremity of the magnet in a tube form (52) to at least 2 insulated diodes (56) & (57) that let the magnet in a tube form (52) contract and de-contract itself by using the magneto-contraction caused by the repeated short circuiting of the very low AC current at both extremities of the large insulated magnet (52) with the 2 insulated (or more) diodes (56) & (57).

The insulated magnet (52) that vibrates generate a vibrating magnetic magnetic field in the core (49) made of a magnetic alloy (silicon steel, ferrite, iron-nickel alloy . . . ) that amplifies the vibrating magnetic inductive field from the vibrating magnet (52) in coil (51) and generate a higher vibrating (AC) inductive current and AC power in the output (58) &(59) of coil (51).

Coils (51) uses insulated copper wire, (as an example). The coil (51) and the core (49) should have the adequate impedance to resonate with the frequency of the vibrating magnet; to increase the inductive current in the coil (51), this means that coil (51) should have the right dimensions, numbers of spires, . . . and the core (49) should have the right dimension, form, . . . to resonate with the frequency of the vibrating magnet (52). Magnet 52 vibrates by the repeated short circuiting of the low AC voltage at both ends of the magnet 51 that let the insulated magnet contract and de-contract itself any magneto-contraction & de-contraction repeatedly.

The AC power produced continuously without adding external power can be increased by connecting it to the input of a new type of transformer as detailed in FIG. 3.b or converted to DC power with diodes. Zener diode(s) instead of 2 diodes (45) & (46) can generate pulsating DC power continuously without adding external power.

FIG. 4.c illustrate a 3 rd structure of an infinite auto power generation device 8 used as AC power generator made with a magnet in a C form and a coil with a core made with a magnetic alloy (ferrite, silicon steel, iron-nickel alloy . . . ) and 2 diodes and HV anti static insulators,

where:
(60) & (61) are the outputs of the coil generating (AC current)
(64) is the coil
(63) is the core (made of ferrite, silicon steel, supermalloy . . . ) of the coil
(65) is the (metal, alloy, ferrite, . . . ) magnet in the form of C
(66) & (67) & (68) & (71) is the HV antistatic insulator
(69) & (70) are the 2 (fast switching) diodes that together make an infinite auto power generation device.

Coil (64) & core (63) (that can be replaced by a transformer) and the HV anti static insulator (66), (67), (71) that surround a magnet (65) shaped in a C form that vibrates continuously by connecting both sides of the longest extremities of the magnet (65) to (at least) 2 (inverted) diodes (69) & (70) in parallel and putting both sides of the extremities of the magnet (65) (in a C form) very close to both side of the surface of the core (63) the coil (64) that are separated with a (very) thin HV anti-static insulator (68) between the very narrow spaces separating both side of the magnet (65) and both sides of the core (63) that is surrounded by the coil (64).

By connecting both extremities of the insulated magnet (65) to at least 2 inverted diodes (69) & (70) in parallel (for example), the magnet (65) contracts and de-contracts itself by using the magneto-(de)contraction caused by the very low current AC voltage between both extremities of the large magnet (65) being repeatedly short circuited by the 2 (or more) insulated diodes (69) & (70), when kept very well insulated by the HV anti-static insulator (66) & (67) & (68) & (71).

The magnet (65) in a C form that vibrates, generates a vibrating magnetic induction field that is amplified in the core (63) (made of ferrite, silicon steel, iron-nickel alloy, . . . ) creating in coil (64) an AC current in the output (60) and (61) of coil (64).

The coil (64) and the core (63) should have the adequate impedance to resonate with the frequency of the vibrating magnet (65); to increase the inductive current in the coil (64), this means that the coil (64) and core (63) should have the right dimensions, numbers of spires, . . . and dimension, form, . . . to resonate with the frequency of the vibrating magnet (65). The AC power produced by this infinite auto power generation device is continuous without adding external power and can be converted to DC power with diodes.

The AC power produced continuously without adding power can be increased by connecting it to a new type of transformer as detailed in FIG. 3.b. If 2 Zener diode(s) are used instead of the 2 diodes (69) & (70) then a pulsating DC power can be produced continuously without adding external power.

FIG. 4.d illustrate a 4th structure of an infinite auto power generation device 8 used as a AC generator and/or AC charger made with a transformer with 2 coils with a core made with a magnetic alloy (made with silicon steel, ferrite, iron nickel alloy . . . ), a HV (High voltage) anti static insulator (PET, oil, polyetheylene foil . . . ), 2 diodes and a strong magnet in rod form where:
(72) is a magnet that can be an iron, nickel, cobalt alloy magnet, or other metal alloy magnet, (or even also ferrite magnet . . . ) shaped (for example) in a rod form (but it can also be in C or U or other form, . . . ),
(74) & (75) are 2 inverted (fast switching) diodes
(79) & (80) are one of the 2 outputs of output coil (77) of the transformer (AC current)
(81) & (82) are the other 2 outputs of output coil (78) of the transformer (AC current)
(77) is one of the coils in the transformer
(78) is the other coil in the transformer
(72) is the magnet in the form of a rod
(73) is the HV (antistatic) insulator
(74) & (75) are the 2 inverted (fast switching) diodes
(76) is the core of the transformer

An alternating (AC) current is generated indefinitely continuously in coil (77) and (78) by keeping the surface of side at the longest extremity of the magnet (72) very close to the core (76) of the transformer and by putting a very thin HV anti-static insulator (73) (for example PET, oil, . . . ) between the very narrow space separating the surface of one side of the magnet (72) and the surface of the core (76) of the transformer.

By connecting both surfaces at both extremities of the insulated magnet (72) to at least 2 insulated inverted diodes (74) & (75), the magnet contract and de-contract itself by magneto contraction and de-contraction caused by the very low current AC voltage between both extremity of the large insulated magnet (72) that the 2 (or more) diodes (74) & (75) short circuit repeatedly. The magnet (72) that vibrates generate a magnetic induction field that is amplified in the core (76) (made with ferrite, silicon steel, iron-nickel cobalt alloy, or other magnetic alloy, . . . ) of the transformer that create in coil (77) & (78) an AC current that produce AC power in the outputs (81) and (82) and a AC power in outputs (79) and (80) of the transformer used in the infinite auto power generation device.

The coil (77) & (78) and the core (76) should have the adequate impedance to resonate with the frequency of the vibrating magnet (72); to increase the inductive current in the coil (77) & (78), this means that the coil (77) & (78) should have the right dimensions, numbers of spires, . . . and the core (76) should have also the right dimension, form . . . to resonate with the frequency of the vibrating magnet (72). The AC power produced can be increased further by connecting the outputs (81)& (82) and/or outputs (79) & (80) to input of a new type of transformer as detailed in FIG. 3.b, and can be converted to DC power with diodes. DC pulsating power can be in the outputs if zener diode(s) replace diode (74),(75).

FIG. 5.a illustrate seen from above, while FIG. 5.b illustrate seen from one side an infinite auto power generation device 9 used as mechanical generator; a motor made with at least 1 circular magnet and 1 or more other magnets that generate also mechanical & electrical power continuously without external power if connected to a dynamo, where:
(83),(87) is the case surrounding the motor
(84) is the external rod magnet with its own axis (164) with its South magnetic pole below the rotor where the circular magnet is showing also its south magnetic pole
(85) is the axis of the rotor (90) connected to the circular magnet (86)
(86) is the circular magnet connected to the rotor (90)
(88) is the 2sd external rod magnet fixed on its own axis (163) with its North magnetic pole above the rotor where the circular magnet (86) shows also its North magnetic pole
(165) is the adjust knobs to manually change/turn the position/angle of magnets (88)
(163) is axis that let magnet (88) turn/change position/angle against circular magnet (86)
(166) is the adjust knobs to manually change/turn the position/angle of magnets (84)
(164) is axis that let magnet (84) turn/change position/angle against circular magnet (86)
(89) is the free space between the magnets, air or vacuum . . .
(90) is the rotor connected to the circular magnet,
(91) is the hole where the axis of the rotor is rotating, in a hole (that can be magnetic gear) that is in the case (83)& (87) surrounding the motor.
(93) is the side of internal circular magnet with its South magnetic pole below the rotor and circular magnet
(92) is the side of internal circular magnet with its North magnetic pole above the rotor and circular magnet that together create the infinite auto power generation device; a motor with as an example:
   a circular magnet (86) connected to a rotor (90) to turn around its axis (85) freely with the south magnetic pole (93) below circular magnet (86) and North pole (92) above circular magnet (86),
   with below the circular magnet (86) one (or more) magnet(s) (84) in the form of a rod (or C or U or other form) with its South magnetic pole below the circular magnet (86) showing also below its South magnetic pole.
   and with above the circular magnet (86) one (or more) other magnets (88) in the form of a rod (or C or U or other form) with its North magnetic Pole above the circular magnet (86) showing also its North magnetic pole).

(The 2 rod magnets (84) and (88) can also be replaced by one, or more rod magnet(s) bent in a U or C or other form with:
magnet [as with (84)] but in a C or U or other similar form is placed with its South magnetic pole below the circular magnet (86) showing also its South magnetic pole,
while the same magnet [as with (88)] but in a C or U or other similar form shows its extremity with its North magnetic pole above the circular magnet (86) that is also showing above its North magnetic pole.

The magnet(s) (84) & (88) in a rod (or U or C or other form) are fixed around their axis (164) & (163) with a variable adaptable angle, that can be kept with an adjust knobs (165) & (166) (that if coupled with a chain form 1 adjust knob), near the circular magnet (86) to produce a rotation of the circular magnet (86) and of the rotor (90) around its axis (85).

The magnet(s) in the form of a rod (84) & (88) in a U or C or other form) are placed in the angle that allow magnetic repulsion forces below and above the circular magnet (86) that is connected to its centre to a rotor to be able to rotate freely around its axis (85), because of the combined repulsive magnetic forces of the 2 (or 3 or more) rod magnets (84) & (88) that act as a couple of magnetic repulsive forces against the magnetic forces of the circular magnet (86) resulting in a circular motion of the rotor (90) around its axis (85) that let the motor turn freely continuously without adding external power.

A combination of the magnets in a C or U or other form replacing rod magnets (84)&(88) can be used to create simultaneously repulsive magnetic forces against circular magnet (86), both below & above circular magnet (86), with more than 1 magnet in a C or U or similar form.

This is achieved by 2 having magnet(s) (84) & (88) in the form of a rod being replaced by 2 magnets in a U or C or other form placed/fixed in the best angle around their axis (163) & (164) that allow magnetic repulsion forces both below and above the circular magnet (86) that is connected to its centre to a rotor (90) to be able to rotate around its axis (85), where one (or more) of the magnet(s) bent in a U or C or other form is placed with:
its South magnetic pole placed below the circular magnet showing also its South magnetic pole,
while the same magnet in a C or U or similar form shows its extremity with its North magnetic pole above the circular magnet (86) also showing above its North magnetic pole, the magnet(s) in a U or C or other form) are placed near/close to the circular magnet with the best angle/direction with adjust knob (165) & (166) that allow magnetic repulsion forces below and above the circular magnet (86) connected to its centre to a rotor (90) to rotate freely around its axis (85), caused by the combined repulsive magnetic forces of the 2 magnets.

An other combination of magnets in a rod or C or U (or other) form can be added to create simultaneously a repulsive and attractive magnetic force against the circular magnet (86), this/these added magnet(s) in a C or U, . . . form act as an additional magnetic force couple that generate more mechanical power from this infinite auto power generation motor, by adding 1 or 2 or more other magnet(s) in a U or C or other form that can be placed in the best angle/direction that allow magnetic attractive forces below and above the circular magnet (86) connected to a rotor (90) to let it to rotate freely around its axis (85) with more power, by placing:
the 1 or 2 other (or more) added magnet(s) in a C or U form with its extremity with North magnetic pole placed below circular magnet (86) that is showing its South magnetic pole,
while the same 1 or 2 other (or more) added magnets in a C or U or other form shows its extremity with its South magnetic pole above circular magnet (86) showing above its North magnetic pole,

When both repulsive and attractive magnetic forces of the 2 or 4 or more magnets (in a rod) or C or U (or other) form are coupled together, this to let the circular magnet (86) turn freely around its axis (85) with more power and the infinite auto power generation device; auto power generation motor produce (for example) more mechanical (convertable to electrical, . . . ) power continuously without adding external power.

Each of the magnets in a rod or C or U or other form allowing repulsive and/or attractive magnetic forces against the circular magnet (86) can also be fixed at the middle of their length (or at the end with the bend extremity of the magnet in C or U or other form) with their own axis (163) & (164) allowing it to move/turn (remotely or) manually with the adjust knob (165) & (166) by an angle of ˜90 degrees around their axis (163) & (164) to have 2 different direction and/or position against the circular magnet (86), allowing circular magnet (86) and the rotor (90) to rotate on its axis (85) in one or opposite direction; clock or anti-clockwise.

The magnets in (a rod) or C or U (or other) form creating repulsive (and/or attractive) magnetic forces against the circular magnet (86) can also be fixed an moved/placed or turned around their axis (163)& (164) (remotely or) manually with knob (165) &(166) between 0 to 180 degrees from their usual direction/position against circular magnet (86) to allow the circular magnet (86) and the rotor (90) to rotate freely around its axis (85) with less/more power, or less/more speed, or in the opposite direction, or stop rotating by: lowering/increasing or inverting or stopping the magnetic repulsive and/or attractive forces from the magnet(s) with a rod, C, U, . . . form against the circular magnet (86), this is done by; changing the angles/distance of repulsion (and/or attraction) of the magnetic forces of magnets with (a rod) or C or U (or other) form against the circular magnet (86) that is rotating around its axis (85).

A simpler version of infinite auto power generation device with constant rotation can use prefixed magnet in C, U, . . . form without adjust knobs (166) & (165) & axis (164) & (163).

The circular magnet (86) turning freely continuously around its axis (85) produce mechanical power continuously without external power convertable to electric power by connecting the axis (85) of the circular magnet (86) of the motor (build with 2 or 3 or more magnets) with the axis of a dynamo producing AC, DC electric power that can have its output connected to the input of a new type of transformer as in FIG. 3.b, with an increased (amplified) AC power at the output of the new type of transformer as in FIG. 3.b.

FIG. 5.c show from above & FIG. 5d from one side how this infinite auto power generation device 10 can be made to be used simultaneously as a mechanic and AC power generator, by letting the circular magnet (86), connected to a rotor and axis (85), have a succession of holes (182) separated by no holes (183) with both the same diameter as a hole along its circumference, the 4 extremities (184) & (185) & (186) & (187) (with the size of the diameter of a hole) of the 2 same inverted coils (188) & (189) in series & with both a C shape core (191) &(192) and near each other are facing simultaneously a hole & not a hole (repeatedly) and when circumference (190) of circular circular magnet (86) is turning; it creates by induction AC in the 2 coils, with both a C shape core (191)& (192).

Its produced AC electric power output can be connected to the input of the new type of transformer (A) as detailed in FIG. 3.b to further increase the electric power, from the infinite auto power generation motor (if holes in circular magnet), that comes from the electric output of the new type of transformer (A) as detailed in FIG. 3.b, this increased power by the new type of transformer, detailed in FIG. 3. can be repeated many times.

FIG. 6. illustrate an infinite auto power generation device 11 made with a usual electrical motor using AC/DC current that contains a rotor (122) made (usually) of silicon steel sheets, (or other magnetic alloy, . . . ) sheets that have a shape (form) of the capital letter I, that are glued, and bound together to form a tri-dimensional rotor with a I form, where;
(120) is a static magnet of the electrical motor showing a magnetic pole in front of one of the two extremities of the rotor
(121) is an other static magnet of the electrical motor showing a magnetic pole in front of the other extremity of the rotor
(122) is the rotor with a I form of the electrical motor
(123) and (124) are the coils made with insulated magnetic alloy wires that are winded around the branches of the rotor (122) of the new type/model electric motor
(125) is the axis placed at the middle of the rotor (122) of the new type of electric motor And where the coils (123) and (124) are made with in an insulated magnetic alloy wire that amplify the alternating magnetic field created by the DC and/or AC current in the coil(s)
(123) and (124) that are winded around the 2 branches of the rotor (122) that has a I shape with 2 branches separated by the axis (125) on the rotor (122).

Each extremity of the I shaped rotor create an alternating magnetic field against (near and in front of) the constant magnetic field of magnet(s) (120) and (121). These alternating magnetic forces from the rotor (122) and magnets (120) & (121) turns the rotor when a current is the coils (123) & (124).

Usual DC and AC electrical motor, use coils with insulated copper wire, but this infinite auto power generation motor using DC and/or AC current is made with coils using insulated magnetic alloy wires that can be, for example:
insulated silicon steel wire, or insulated iron-nickel alloy wires . . . that amplify the strength of the alternating magnetic field in the coils (123) and (124) created by the (alternating) current in the insulated silicon steel [Fe (95%) & Si (˜5%)] wires, (or insulated iron-nickel alloy [Fe (25%-75%) & Ni (75%-25%)] wires . . . ) more than in coils made with insulted copper [Cu (˜99%)] wire used in usual electric motor. This increased alternating magnetic field in coil (123) and (124) made with insulated magnetic wire is again amplified in the core of rotor (122) made of silicon steel, . . . .

This stronger alternating magnetic field at both extremities of the rotor (122) against the magnetic field of the (electro) or static magnet(s) (120) & (121), that surround the rotor (122) increase the magnetic forces between both extremities of the rotor (122) and the facing static magnets (120) & (121) (and/or electro-magnets) that surround the rotor. This result in more mechanical power being delivered by the infinite auto power generation device; (an electrical motor using coils with insulated magnetic alloys wire) than the same usual other electrical motor made with coils using insulated copper wire while the same
in an electrical motor made with insulated copper wire &
in an electrical motor made using insulated magnetic alloys wire

If the rotor of the infinite auto power generation device used as a electrical motor made with magnetic alloys wire(s) is connected to the axis of a dynamo to generate electrical power, a part of the electrical power from the dynamo can be used to power the electrical motor using coils made with magnetic alloys wire that turns the dynamo.

This invention can be applied to any other type, genre, model of electrical motor that uses core made of magnetic alloy and coils made of insulated copper wire. Where the coils made of insulated copper wire can be replaced with coils made with insulated magnetic alloy wire(s), that can be for example:
insulated silicon steel wire, or insulated iron-nickel wire, . . . whether the electrical motor use DC and/or AC current, and with any rotor of any shape (form), for example with a rotor with a:
I shape that has 2 branches, 2 coils separated by the axis of the rotor, or
Y shape that has 3 branches, 3 coils separated by the axis of the rotor, or
X shape that has 4 branches, 4 coils separated by the axis of the rotor or rotor with any other shape in the electrical motor.

This invention also applies to electrical motor with a rotor with no coils, where the copper wire forming the coils are on the stator (where the stator is made of magnetic alloys with insulate copper wire that is inserted outside the rotor; (on the stator placed around the rotor)

The insulated copper coils used on the stator can be replaced by coils with an insulated magnetic alloy wire, for example: insulated silicon steel wire, or insulated iron-nickel alloy wire, . . . to have an infinite auto power generation motor that can generate more mechanical power continuously without adding external power.

By connecting this new type of electric motor to a dynamo by their axis, and a part of the electric output of the dynamo electrically powering the infinite auto power generation device; which is a new type of electric motor (made with magnetic alloy wires), more electrical and mechanical power can be generated continuously without adding external power.

To increase the power output, the electric output of the dynamo (connected to the new type of motor by their axis), is shared to the input of at least 1 new type of transformer as detailed in FIG. 3.b with its amplified AC output connected to the electric input of the infinite auto power generation device (that is the new type of electric motor made with insulated magnetic alloy wire) which give more electric power to the new type of motor producing more mechanical and electric power.(this can be used for vehicles, cars, trucks, trains, planes, space craft . . . or electric drills, washing machines, . . . )

A few combinations of devices from my invention (mentioned above) that can be used together include (as examples):
Combination 1: the use of 3 new type of transformer as detailed in FIG. 3.b to generate more power from the circuit in FIG. 3.a by using circuit as detailed in 3.a
Combination 2: use 1 new type of transformer as detailed in FIG. 3.b to amplify the power from 1 or more infinite device(s) detailed in FIG. 4.a, FIG. 4.b, FIG. 4.c, FIG. 4.d
Combination 3: use 1 or more new type of transformer as detailed in FIG. 3.b to amplify the power generated by the device mentioned in FIG. 2.a
Combination 4: Combination 1, and Combination 2, and Combination 3 can be used to store their produced power to charge or recharge or as charger of high large capacitor(s), and high power (rechargeable) battery/ies as detailed in FIG. 1. a to FIG. 1.g; (1;a,b,c,d,e,f,g)
Combination 5: use the new motor as detailed in FIG. 6 with a dynamo &the transformer detailed in 3.b and/or in FIG. 3.a to generate more power, that can be shared with the new motor in FIG. 6 to produce more mechanical and electrical power.
Combination 6: use many devices as detailed in FIG. 2.f connected in series, parallel, loop with the device(s) detailed in FIG. 2.e to produce more powerful electron beam, ion beam & more & powerful HV electrostatic power for thrust engine with ion beam
Combination 7: is any other combination(s) of device(s) mentioned from FIG. 1.a to FIG. 6 used together with infinite auto power generation devices as detailed from FIG. 1.a to FIG. 6.

FIG. 7.c illustrate an infinite auto power generation device 19 made with 2 circuits used in FIG. 7.a, 1 circuit let the voltage and current go in one direction when activated then the other circuit is activated letting the current go in the opposite direction. The full circuit in FIG. 7.b act as an inverter that switch botch circuits on/off by using:
resistors with the following values:
1,6 K in the components (247) & 248) & (249 (in FIG. 7.b)
47 K in the components (250) & (251) (in FIG. 7.b)
160 K in the component (252)
2,2 K in component (253) & 1,2 K in component (254) & (260)
120 K in component (255)
470 K in component (256) & (257) & (261)
   capacitor with the following values:
1000 uF in component (245) & (246) & 47 pF in component (258)
   fast switching diodes 1n4148 in the components: (234) & (235), (236), (237), (238), (239, (240), (241), (242), (243), (244)
   NPN transistor (BC547) in the components: (227), (228), (229), (230)
   NPN transistor (2N6052) in the component (224)
   PNP transistor (2N4001) in the components: (231), (232), (233)
   PNP transistor (2N6059) in the component (263)
   and 2 (rechargeable) batteries for 2 circuits in components: (220), (221), (222), (223)
   that recharge the 2 batteries to be charged alternately in the 2 circuits: (225), (226)

The frequency of the alternatively switch on/off 2 circuits is controlled by an electric oscillator generating a sinus or square wave voltage at (259) & (262). This circuit is an example to generate continuous AC current at (263) & (264) without external power.

1. Infinite auto power generation devices generate power continuously without adding external power and comprise 19 models listed below:
infinite auto power generation device 1: is an auto rechargeable battery made of at least 3 (rechargeable) batteries with 3 different power storage and 3 same voltage in paralleled with a switch
infinite auto power generation device 2: is an auto rechargeable battery made of 2 sets of 2 (rechargeable) batteries with 2 set of different power and 4 same voltage in parallel & in series with a switch
infinite auto power generation device 3: is an auto rechargeable charger made of 2 or 3 or 4 (rechargeable) batteries with different power storage and same voltage in parallel & in series with a switch
infinite auto power generation device 4: is an auto rechargeable charger made of at least 3 (storage) different capacitors and/or (rechargeable) batteries with same voltage in parallel & in series with a switch
infinite auto power generation device 5: is a AC power generator made with at least 3 (high and/or low frequency) different capacitors values with same voltage in parallel with a switch or resistor
infinite auto power generation device 6: is a AC power generator made with at least 3 transformers with same voltage but 3 different power in parallel,
infinite auto power generation device 7: is a AC power generator made with 1 or 2 new type of transformers in a loop, using insulated magnetic alloy wires in the input coil and insulated non magnetic alloy wire in the output coil
infinite auto power generation device 8: is a AC power generator made with (a) coil(s) with a core near an insulated magnet vibrating & connected at its both extremities to 2 parallel insulated inverted diodes
infinite auto power generation device 9: is a mechanical power generator (or motor) made with a circular magnet spinning on an axis by magnetic force created by movable/fixed magnet(s) in rod, C, U, . . . or other form near the circular magnet
infinite auto power generation device 10: is a mechanical & AC power generator made with a circular magnet with holes surrounded by coils that is spinning on an axis by magnet(s) in rod, U, . . . form near the circular magnet
infinite auto power generation device 11: is a new type of AC/DC electric motor made with coils using insulated magnetic alloy wires (that increase more the alternating magnetic field in the coils and in the rotor/stator of the motor that can be connected by their axis to a dynamo powering electrically the new type of motor
infinite auto power generation device 12: is a AC & DC power generator made with disymetric capacitor(s) that has 2 electrodes with different sizes separated by a thin HV insulator that are kept insulated by a high voltage insulator
infinite auto power generation device 13 is a transformer and AC & DC power generator made with 2 insulated electric wires separated by a HV insulator spinned against each other in the middle of their length, and kept in a HV insulator
infinite auto power generation device 14: is an electron/ion beam & plasma generator made with modified insulated disymetric capacitor with 2 electrodes of different sizes with each a hole, separated by a thin HV insulator with a hole
infinite auto power generation device 15: is a High power HV & high frequency AC & DC power generator made with 2 or more disymetric capacitors (with 2 insulated different wires separated by a HV insulator) in series, parallel or loop.
infinite auto power generation device 16 is a AC & DC power generator made with 2 insulated electric wires separated by a HV insulator spinned against each other at the end of their length in a HV insulator.
infinite auto power generation device 17: is a power generator that can used as battery charger with at least 2 or 3 similar electric (rechargeable) batteries of at least 1,2 Volt and at least 10 mW power storage, as an example the − pole of battery 1 is connected to both cathodes of at least 1 or 2 diodes in parallel and the − pole of an (electrolytic) capacitor of 1000 uF (212) (with a voltage superior than battery 1 and battery 2) and to the emitter of an NPN transistor (BC547), while the + pole of battery 2 is connected to the anodes of at least 1 or 2 diodes in parallel and to the + pole of the electrolytic capacitor of 1000 uF and to the collector of an NPN transistor (BC547), and the base of the transistor is connected to a resistor (47K Ohms) and the other extremity of the resistor is connected to the + pole of battery 2. The + pole of battery 1 is connected to the + pole of battery 3 to charge and the − pole of battery 2 is connected to the − pole of battery 3 to charge.
infinite auto power generation device 18: is an electrostatic electron beam generator build with at least 2 inverted parallel fast switching diodes kept in or on a HV insulator, with one extremity with a metal ring at the anode and at the other extremity a needle point at the cathode.
infinite auto power generation device 19: is a AC current generator using 2 infinite auto power generation 17, that are alternately activated to let 2 DC current from each 2 circuit alternate in 2 directions.

2. An infinite auto power generation device 1 build with (rechargeable) battery/ies for the purpose of generating and/or storing DC power or as charger device producing DC power continuously without adding external power comprise at least:
3 (rechargeable) batteries; battery 1 and battery 2 and battery 3, each of these 3 (rechargeable) batteries; battery 1 and battery 2 and battery 3 can be made of identical (rechargeable) batteries with a voltage (V) and the same power storage (W/h) connected in series s (pole − to pole +) to form one battery with a higher voltage (higher than 1 V) that is equal to the added voltage (V) of all the batteries in series with a power (W/h) equal to the power of one (or each) battery in series, each of these at least 3 (rechargeable) batteries; battery 1 and battery 2 and battery 3 with the same (higher than 1 V, if necessary) voltage (V) have at least 2 or 3 different storage powers (W/h), and are connected in parallel (meaning that); pole + of battery 1 to pole + of battery 2 to pole + of battery 3 and pole − of battery 1 to pole − of battery 2 to pole − of battery 3, and 2 or 3 inverted (zener) diodes in parallel (or other equivalent circuit) can be connected between the pole + (or −) of battery 2 and pole + (or −) of battery 3 to avoid the discharge of battery 3 by disconnecting it from battery 1 and battery 2, when battery 3 is fully charged, and reconnecting it to battery 1 and battery 2 when not fully charged, the pole + and pole − of battery 3 are the output of the infinite DC auto power generators, battery 3 should have the highest power storage (W/h) while battery 2 and battery 1 should have 2 different lower power storage (W/h) while battery 1 and battery 2 and battery 3 should have all the same voltage (V), more than 3 (rechargeable) batteries with the same voltage (V) but different power storage (W/h) can be used in parallel.

3. An infinite auto power generation device 1 & 17, as claimed in claim 2 & 50; with a voltage of about 1 V to 50 volt, can be used as a one of the devices for the purpose of manufactoring the following products that can function continuously (by having DC electrical power continuously without adding external power) that comprise at least:
the auto power generation device(s) 1 as claimed in claim 2 that uses the same (similar) voltage (V) and power storage (W/h) as the usual (rechargeable) battery/ies or power unit used in the manufactoring of the products listed below;
mobile phone, laptops, printers, electric drill, electric torch, watches, smart watches, handheld calculator and computer, translator, camera, electric bicycles, car and truck battery, TV sets, electric pump, toys battery charger, A and AA and AAA battery charger, rechargeable A and AA and AAA battery charger, electric compressor battery charger, androids battery charger, drones battery charger, robots battery charger, electric car battery charger, electric planes battery charger, electric scooter battery charger, electric bicycle battery charger, that are manufactured by replacing or recharging the usual (rechargeable) battery/ies or capacitor(s) and/or power unit(s) in the products listed above with the auto power generation device(s) as claimed in claim 2 that use(s) the same (similar) voltage (V) and power storage (W/h) as the usual (rechargeable) battery/ies or power battery/ies or power unit(s) used initially in products listed above, to manufacture these products that can function continuously without adding external power that can be also called infinite auto power generation device.

4. An infinite auto power generation device 1 & 17 as claimed in claim 2 & 50; with a voltage of about 1 V to 500 volt (V), can be used as a one of the devices for the purpose of manufactoring the following products that can function continuously (by having DC electrical power continuously without adding external power) that comprise at least:
the auto power generation device(s) as claimed in claim 2 that uses the same (similar) voltage (V) and power storage (W/h) as the usual (rechargeable) battery/ies or power unit used in the manufactoring of the products listed below; electric bicycles battery and battery charger, car & van & truck's battery and battery charger, TV sets battery and battery charger, electric pump's battery and battery charger, toy's battery and battery charger, electric compressor battery and battery charger, robot's battery and battery charger, drones battery and battery charger, electric car battery charger, electric planes battery and battery charger, electric scooter battery and battery charger, wind turbine battery and battery charger, solar and hydro and hydrogene power station, battery and battery charger, wind turbine storage battery and battery charger, factory robot battery and battery charger, drones battery and battery charger, electric car battery charger, electric planes battery and battery charger, electric scooter battery and battery charger, wind turbine battery and battery charger, that are manufactured by replacing or recharging the usual (rechargeable) battery/ies or capacitor(s) and/or power unit(s) in the products listed above with the auto power generation device(s) as claimed in claim 2 and that use(s) the same (similar) voltage V and power storage (W/h) as usual (rechargeable)battery/ies or power battery/ies or power unit(s) used initially in the products listed above to manufacture these products that can function continuously without adding external power and that can be called infinite auto power generation device.

5. An infinite auto power generation device 3 for the purpose as charger to recharge (rechargeable) batteries and/or (storage) capacitors with DC power continuously again and again without adding external power continuously comprise at least:
2 (rechargeable) batteries; battery 1 and battery 2 with the same voltage (V) that have 1 or 2 different storage powers (W/h), that are connected in parallel (meaning that); pole + of battery 1 to pole + of battery 2 connected also to pole + of the (rechargeable) battery to recharge, and pole − of battery 1 to pole − of battery 2 connected also to the pole − of the (rechargeable) battery to recharge, the (rechargeable) battery 3 to recharge must also have about the same voltage (V) as battery 1 and battery 2 and should have a higher but different storage power (W/h) than battery 1 and battery 2 used in the charger, 2 or 3 inverted (zener) diodes in parallel (or equivalent circuit acting as switch or relais) can be connected between the pole + (or −) of battery 2 and the pole + (or −) of the (rechargeable) battery 3 that has to be recharged, these 2 or 3 inverted (zener) diodes in parallel (or other equivalent circuit) is to avoid the discharge of the (rechargeable) battery 3 that has to be recharged; by switching it off from the charger when fully charged and switching it on to the charger when battery 3 is discharged.

6. An infinite auto power generation device 4 for the purpose as DC charger device for (rechargeable) battery/ies and/or capacitors for the purpose of keeping capacitor(s) or battery/ies or other devices charged with DC continuously without adding external power continuously comprise at least 2 (or more) capacitors or (rechargeable) batteries with the same voltage (V) that have 1 or 2 (or more) different storage powers (W/h) or capacity (F), that are connected in parallel (meaning that); pole + of capacitor 1 or (rechargeable) battery 1 to pole + of capacitor 2 or (rechargeable) battery 2 that is also connected to the pole + of the capacitor or (rechargeable) battery to recharge, and pole − of capacitor 1 or (rechargeable) battery 1 to pole − of capacitor 2 or (rechargeable) battery 2 that is also connected to the pole − of the capacitor or (rechargeable) battery to recharge. All the capacitor or (rechargeable) battery to recharge should also have about the same voltage (V) and should have a higher capacity (F) or power storage (W/h) than the 1 or 2 capacitor 1 &2 or (rechargeable) batteries 1 &2 or battery 1 & capacitor 2 used in the charger, 2 or 3 inverted (zener) diodes in parallel (or an equivalent circuit) can be connected between the pole + (or −) of capacitor 2 (or rechargeable battery 2) and the pole + (or −) of the capacitor or (rechargeable) battery that has to be recharged, these 2 or 3 inverted (zener) diodes in parallel (or other equivalent circuit) is to avoid the discharge of the capacitor or the (rechargeable) battery that has to be recharged by switching it on and off from the charger.

7. An infinite auto power generation charger device 4 made with capacitors and/or (rechargeable) batteries with voltage from 1V to 250 V, as claimed in claim 5 and in claim 6, can be used as a one of the device(s) for the purpose of manufactoring the following products that can function continuously (by having DC electrical power continuously without adding external power) that comprise at least:
the infinite auto power generation device(s) 4 as claimed in claim 2 and/or as claimed in claim 5 and in claim 6 that uses the same (similar) voltage (V) and power storage (W/h) as the usual (rechargeable) battery/ies or power unit(s) used in the manufactoring of the products listed below; laptop battery charger, flash light battery charger, lighting & radio & TV battery charger, camera battery charger, toys battery charger, A and AA and AAA battery charger, rechargeable A and AA and AAA battery charger, electric hoover battery charger, ventilator battery charger, electric bicycle battery charger, electric scooter battery charger, car battery charger, truck battery charger; that are manufactured by replacing and/or recharging the usual (rechargeable), batteries or capacitors and/or power unit(s) in the products listed above with the auto power generation device(s) as claimed in claim 2, and/or as claimed in claim 5 and in claim 6 to charge the usual (rechargeable) batteries or capacitors and/or power unit(s) in the products listed above with the build in (or added externally) auto power generation device(s) that uses the same (similar) voltage (V) and power storage (W/h) as the usual (rechargeable) battery/ies and/or power unit(s) used initially in the products listed above, to manufacture these products that can function continuously without adding external power that are called infinite auto power generation device.

8. An infinite auto power generation device 1 & 2 & 3 & 4 & 17 for the purpose as auto power generation device(s) that uses the same (similar) voltage (V) and power storage (W/h) as the usual (rechargeable) battery/ies and/or power unit(s) used initially in the products listed in claim 7 to manufacture these products that can function continuously without adding external power that are called infinite auto power generation device.
An infinite auto power generation device 1 & 2 & 3 & 4 & 17 for the purpose as charger, as claimed in in claim 2 and claim 5 and in claim 6 & 50 with a voltage from 5 V to 500 V, can be used as a one of the devices for the purpose of manufactoring the following products that can function continuously (by having DC electrical power continuously without adding external power that comprise at least:
the infinite auto power generation device(s) 1, 2, 3, 4 as claimed in claim 2 and in claim 5 and in claim 6 that uses the same (similar) voltage (V) and power storage (W/h) as the usual (rechargeable) battery/ies or capacitor(s) or power unit(s) used in the manufactoring of the products listed below;
car battery charger, truck battery charger, ship battery charger, wind turbine battery charger, wind turbine storage battery charger, battery charger used in power station, battery charger used for producing hydrogene, that are manufactured by replacing and or recharging the usual (rechargeable) batteries, capacitors, and/or power unit(s) in the products listed above with the build in (or added, used externally) auto power generation device(s) as claimed in claim 2, and/or as claimed in claim 5 and claim 6 to recharge the usual (rechargeable) batteries or capacitors and/or power unit(s) in the products listed above with the build in (or externally added) auto power generation device(s) that uses the same (similar) voltage (V) and power storage (W/h) as the usual (rechargeable) battery/ies or power unit(s) used initially in the products listed above, to manufacture these products that can function continuously without adding external power which can be called infinite auto power generation device

9. An infinite auto power generation device 12 for the purpose as a generator of continuous DC & AC electro-static and high or low voltage power generator without adding external power continuously comprise at least:
one or more disymetric capacitors, where a disymetric capacitor is made with at least 2 electrodes (that can be metal foils, or metal wires, plastic conductor, or paper, fabric, . . . ) with different size, surface and or volume that are separated by a (thin) high voltage (HV) (anti-static) insulator (for example: paper with paraffine, oil, or PET, glass, . . . or polyethene foil, quartz, glass, silicium, . . . ), and an other very high voltage HV (anti static) insulator, (for example; paper with paraffine, oil, or PET, teflon, . . . ) isolating the disymetric capacitor (s), that allow the largest electrode of the disymetric capacitor to charge itself spontaneously negatively − and continuously and the smallest electrode to charge itself spontaneously and continuously positively +, and the electric charges and voltage (V) and intensity of these 2 electrodes increase continuously when, all the disymetric capacitors are kept complete insulated with a very high voltage HV (anti static) insulator, (for example; paper with a case with paraffine or oil, or PET, teflon, . . . ), that allow continuous production of HV electro (static) power without adding external power.

10. An Infinite auto power generation device 12 used as HV generator and/or electro static generator that is build with (storage) capacitors as claimed in claim 9 with a voltage from 1 to 500 000 V, can be used as a one of the devices for the purpose of manufactoring the following products that can function continuously (by having AC&DC HV electrical power continuously without adding external power) that comprise at least:
the auto power generation device(s) 12 as claimed in claim 9 that uses the same (similar) voltage (V) and the same power storage (W/h) as the usual (high) voltage power unit used in the manufactoring of the products listed below; power device for flash light in camera, very height intensity laser pulse device, spark generators, High Voltage electrostatic generator (to charge HV capacitors), plasma generator, air ionizer manufactured by replacing the usual (rechargeable) batteries or capacitors or power unit in the products listed above by infinite auto power the auto power generation device(s) 12 as claimed in claim 9 that uses the same (similar) voltage (V) and the same power storage (W/h) as the usual (high) voltage power unit used in the manufactoring of the products listed below;
power device for flash light in camera, very height intensity laser pulse device, spark generators, High Voltage electrostatic generator (to charge HV capacitors), plasma generator, air ionizer, that are manufactured by replacing the usual (rechargeable) batteries or capacitors and/or power unit in the products listed above with the infinite auto power generation device(s), and disymetric capacitors as claimed in claim 9, that uses the same voltage (V) and power storage (W/h) as the (high) voltage power unit(s) used initially in the products listed above, to manufacture these products listed above that can function continuously without adding external power which can be called infinite auto power generation device.

11. An infinite auto power generation device 14 used as ion generator device for the purpose of electron or ion beam continuous generation without adding external power continuously that can also be used for thrust engine in space, vacuum or air, or for air ionizer or photocopy machine, or chemical reactions needing beam of charged particles, comprise at least:
one or more (modified) disymetric capacitors, this/these (modified) 1 disymetric capacitor is made with 2 electrodes (that can be metal foils, insulated metal wire, paper, fabric, . . . ) with different size, surface and or volume each of these 2 unidentical electrodes have at least one hole and, are separated by a (thin) high voltage (HV) anti static insulator (PET, polyethene foil, paper with paraffine, oil, glass, mica, quartz, silicium . . . ) that has at least one small or large hole, (with a size similar to the holes in the 2 electrodes) a very high voltage insulator, (for example; paper with paraffine, oil, PET, mica, glass, . . . ), around, under a disymetric capacitor(s) let the largest electrode to charge itself spontaneously negatively − and continuously and let the smallest electrode charged itself spontaneously positively + and continuously, and let the electric charges and voltage and intensity of these 2 electrodes increase continuously, if kept well insulated, and let the electrons, ions flow in the 3 holes; from the hole of − electrode then to the hole of the insulator and ten to the hole of + electrode and these 3 hole are forming together 1 hole and facing each other when the 2 electrodes are separated by the (high voltage) anti-static (piezo & not piezo) insulator (glass, quartz, . . . are insulator and have also piezo electric properties), producing continuously without adding external power an electron/ion beam in air/vacuum, when a very high voltage insulator, (for example; paper with paraffine, case with oil, or PET, mica, teflon, . . . ) is around or under the disymetric capacitor(s) with hole(s).

12. An infinite auto power generation device 14 & 18 made with (modified) disymetric capacitors, as claimed in claim 9, and in claim 11, and diodes as claimed in claim 49 can be used as a one of the devices for the purpose of manufactoring the following products that can function continuously (by having electric power continuously without adding external power) that comprise at least:
the auto power generation device(s) as claimed in claim 9 & 11 & 49 that uses, function with the same (similar) voltage (V) and the same power storage (W/h) or power unit(s) as the usual (high) voltage power unit used in the manufactoring of the products listed below: air ionizer, electron beam generator, ion beam generator, ionic trust engine for space, plasma generator, that are manufactured by replacing the usual (rechargeable) batteries or capacitors and/or, transformer, electron/ion beam generator, power unit(s) in the products listed above by the infinite auto power generation device(s), and (modified) disymetric capacitors as claimed in claim 9 and in claim 11 & 49 that uses the same (similar) voltage (V) and power storage (W/h) as the high voltage power unit(s) used initially in the products listed above, to manufacture these products that can function continuously without adding external power which can be called infinite auto power generation device.

13. An other infinite auto power generator device 15 for the purpose of producing (high voltage) DC & AC electric power and high voltage static electricity continuously without adding external power continuously comprise at least:
one or more disymetric capacitors:
and each disymetric capacitor contains at least;
2 electrodes (that can be conductors; insulated metal wires, . . . ) with different size, surface and or volume that are separated by, a (thin) high voltage (HV) anti static insulator, and a 2sd very high voltage insulator, (for example; paper with paraffine, oil, or PET, . . . ) is around each disymetric capacitor, that allow, and let the largest electrode charge itself spontaneously negatively − and continuously and where the smallest electrode charge itself spontaneously positively + and continuously, (in each disymetric capacitor), and the charges and voltage and intensity of these 2 electrodes in these disymetric capacitors increase continuously, when a very high voltage (HV) insulator, (for example; paper with paraffine, oil, or PET, . . . ), is around all the disymetric capacitors connected in series s or loop by connecting (pole + to pole −),& (pole − to pole +) or (pole − to pole −) and/or (pole + to pole +) this allow, and let each disymetric capacitor act as an inverter and amplifier of charge and electric polarity by choosing as input of the disymetric capacitor the electrode (insulated wire) with the largest size or with the smallest size, and where, by connecting at least 2 or 3 disymetric capacitors in series s (in a loop,) the DC &AC high voltage (HV) (static) electricity power output and the power of the ion beam, (between the cathode − and the anode +) is increased, and produced continuously without adding external power.

14. infinite auto power generation device 12 & 13 & 14 & 15 & 16 & 18 made of disymetric capacitor(s) and diodes, as claimed in claim 9, claim 11, claim 13, claim 49 can be used as a one of the devices for the purpose of manufactoring the following products that can function continuously (by having HV electric power continuously without adding external power) that comprise:
the auto power generation device(s) as claimed in claim claim 12, claim 13, claim 14, claim 15, claim 49 and made with disymetric capacitor or diodes as claimed in claim 9 and in claim 11 and in claim 13 & claim 49 that uses the same voltage (V) and the same (similar) power storage (W/h) as the usual (high voltage) power unit(s) used in the manufactoring of the products listed below;
air ionizer, electron beam generator, ion beam generator, ionic trust engine for space, plasma generator, High voltage generator, high energy pulse laser, power device for flash light in camera, very high intensity laser pulse device, spark generators, High Voltage electrostatic generator (for photocopy machine, . . . ), that are manufactured by replacing the usual (rechargeable) batteries or capacitors and/or (high voltage) power unit(s) in the products listed above with the auto power generation device(s), and disymetric capacitors as claimed in claim 9 and in claim 11 and in claim 13, that use the same (similar) voltage (V) and power storage (W/h) as the (high) voltage power unit(s) used initially in the products listed above, to manufacture them to function continuously without external power.

15. An Infinite auto power generation device 8 for the purpose as generator and storage devices made with transformer, or coil, and a magnet in a rod (button) or C or U or tube or other form, and at least 1 or 2 diodes, and a high voltage HV anti-static insulator insulator for the purpose of producing continuously AC (& DC) electric power (60-100 Hz or other frequencies), without adding external power, comprise at least:
a magnet in rod or button or C or U or tube (or other) form that is connected at both ends of its longest extremities, (where its South and North magnetic pole of the magnet are the strongest) to at least 2 inverted diodes in parallel, and both the magnet and at least these 1 or 2 diodes are kept insulated by,
a very high Voltage anti-static insulator, for examples: paper with paraffine, oil, or Polyethylene foil, or PET, . . . , the insulated magnet vibrates due to the repeated short-circuiting of the very low AC voltage at both extremities of the insulated magnet connected by at least 2 insulated inverted diodes in parallel, that let the magnet contract and de-contract itself due to the magneto contraction and decontraction caused by the repeated short-circuiting of the very low AC voltage at both extremities of the insulated magnet, this create a continuous vibrating magnetic field, and when coil(s), or coil(s) with a core (made of magnetic alloys), or transformer(s) with a core (made of magnetic alloys, for example silicon steel, iron-nickel alloy) that amplify the alternating magnetic field from the vibrating magnet, then this vibrating magnet placed very close (less than a mm) near the coil or core or transformer, generates an induction current continuously in the coil(s), and/or transformer, these output coil(s) & the core(s) of must have the correct impedance to resonate with the frequency of the vibrating insulated magnet, this means the coils, core must have the correct dimension, number of spire, inductance, magnetic permeability to generate the maximum AC output from this infinite auto power generation device.

16. An Infinite auto power generation device 8 made a with coil(s) transformer(s), and at least 1 (strong) magnet, and 1 or 2 diodes and a very high voltage (anti-static) insulator as claimed in claim 15, can be used as a one of the devices for the purpose of manufactoring the following products that can function continuously (by having AC electrical power continuously without adding external power) that comprise:
the auto power generation device(s) 8 as claimed in claim 15 that uses the same voltage (V) and the same (similar) power storage (W/h) as the usual voltage power unit(s) used in the manufactoring of the products listed below, electric AC power generators, portable low power AC electric generator for electric watches, for calculators, for laptops, for mobile phones, for electric charger for batteries or (storage) capacitors, for watches, for digital watches, for smart watches, for TV sets, that are manufactured by replacing the usual (rechargeable) battery/ies or capacitors and/or power unit in the products listed above with the auto power generation device(s) as claimed in claim 15, that uses the same (similar) voltage (V) and power storage (W/h) as the (rechargeable) battery/ies, storage capacitors, power unit(s) used initially in the products listed above, to manufacture these products that can function continuously without adding external power.

17. An Infinite auto power generation device made 5 with (high or low frequency, non polarized, . . . ) capacitors using for example mica, PET, . . . as insulator and with identical electrodes for the purpose of producing, continuously without adding external power continuously, (high or low Frequency) electric (static) voltage and/or AC current at a lower frequency and AC power (60-100 Hz), comprise at least:
2 or 3 non polarized, high or low frequency capacitors (MKP), (F) connected in parallel, these 3 usual capacitors have (about) the same voltage (V) but at least 2 or 3 different capacities (F) and made of 2 same size electrodes separated by an insulator, that are connected in parallel, meaning the 1rst pole of each capacitor is connected to 1rst pole of the other capacitors and the 2sd pole of each capacitor is connected to the 2sd pole of the other capacitors (where a capacitor has 2 identical electrodes), and the output, (high Frequency) electric (static) voltage and/or usual low frequency AC power (60-100 Hz), come from the 2 poles of the capacitor with the highest capacity (F) among the at least 3 capacitors connected in parallel, and all the capacitors have to be kept insulated continuously by a high voltage (HV) (anti-static) insulator to produce alternating current (AC) power continuously without adding external power.

18. An Infinite auto power generation device 15 & 5 & 18 with (high or low frequency, non polarized, oil, mica, . . . ) capacitors as claimed in claim 17 & 49, can be used as an AC power generator & as device for the purpose of manufactoring the following products that can function continuously (by having AC electrical power continuously without external power) that comprise:
the auto power generation device(s) as claimed in claim 17 & 49 that uses the same voltage (V) and the same (similar) power storage (W/h) as the battery/ies, capacitor(s), power units) used in the manufactoring of the products listed below;
portable AC power generator, HV electron/ion generator, air ionizer, ionized gazes generator, high voltage (electro-static) generator, (very) High frequency High voltage generator, that are manufactured by replacing the usual (rechargeable) batteries or capacitors and/or power unit(s) in the products listed above with the infinite auto power generation device(s) as claimed in claim 17, that uses the same (similar) voltage (V) and power storage (W/h) as the (rechargeable) battery/ies, storage capacitors, power unit(s) used initially in the products listed above, to manufacture these products that can function continuously without adding external power which can be called also: infinite auto power generation device.

19. An Infinite auto power generation device 6 used as generator and storage devices made with transformers for the purpose of producing continuously AC electric power (60-100 Hz, or other frequencies), without adding external power continuously, comprise at least:
3 or 4 (high or low frequency) transformers with the same input voltage (V) but with 2 or 3 different output power (W/h), with the 3 inputs of these 3 transformers connected in parallel and in phase, and the 3 identical output voltage (V) of these 3 transformers have 2 or 3 different output powers (W/h) that are connected in parallel and in phase, the 3 output of these 3 transformers are connected in paralleled to the input of a 4th transformer, whose output (of the 4th transformer) is connected to a circuit allowing AC current to flow only from the output of 4th transformer to 3 inputs in paralleled of the (first) 3 transformers to form a loop, where AC power is generated continuously without adding external power.
The output power to be used, comes from a part of the 3 identical output voltage (V) of these 3 transformers, and/or from a part of the output of the 4th transformer, and those outputs produce AC power continuously without adding external power.

20. An Infinite auto power generation device 6 used as AC generator and AC storage devices made with transformers as claimed in claim 19, can be used as a one of the devices for the purpose of manufactoring the following products that can function continuously (by having AC electrical power continuously without adding external power) that comprise:
the auto power generation device(s) as claimed in claim 19 that uses the same voltage (V) and the same (similar) power storage (W/h) as the battery/ies, transformer(s), capacitor(s), power unit(s) used in the manufactoring of the products listed below;
power generator in power station, (portable) electric AC generators, AC generator for electric car(s); electric truck, electric ship, electric van, electric plane, electric spacecraft, that are manufactured by replacing the usual (rechargeable) batteries or capacitors and/or transformer or power unit(s) in the products listed above by the auto power generation device(s) as claimed in claim 19, using the (similar) voltage (V), power storage (W/h) as the (rechargeable) battery/ies, capacitors, transformer (s), power unit(s) used initially in products listed above to manufacture them working continuously without external power & called infinite auto power generation device.

21. An other Infinite auto power generation device 7 used as power generators and made with transformers for the purpose of producing continuously AC electric power (60-100 Hz, or other frequencies) without adding external power continuously, comprise:
1 or 2 electrical transformers that have input coils made with insulated magnetic alloys wire(s); (for example insulated silicon steel wire with 95% iron and ˜5% silicium or, insulated iron-nickel alloy wire(s) . . . with 25%-75% iron and 75%-25% nickel, . . . ) that amplify the alternating magnetic fields inside de coils and the cores of the 2 transformers, this results in a higher alternating inductive current and AC power output in the output coils of the 2 transformers made (usually) with copper coils, these 2 new type of transformers can be connected in a loop; when the output coil (made with insulated copper wire, as an example) of transformer 1 is connected in parallel with the input coil (using insulated magnetic alloy wire) of transformer 2, and when the output coil (made with insulated copper wire, as an example) of transformer 2 is connected in parallel with the input coil (made of insulated magnetic alloy wire) of transformer 1, and when a circuit is added between the output transformer 2 and the input of transformer 1 to let the AC current flow only from transformer 2 to transformer 1 in a loop; to generate more power continuously without adding external power.
The insulated magnetic alloy wire can be made with, for example: insulated silicon steel wire (about ˜5% silicium with ˜95% iron, . . . ), insulated iron-nickel alloy wire (between ˜30% to ˜60% nickel with ˜60% to ˜30% iron), . . . ,

22. An Infinite auto power generation device 7 used as AC power generator and as storage devices made with transformers as claimed in claim 21, can be used as a one of the devices for the purpose of manufactoring the following products that can function continuously (by having electrical power continuously without adding external power) that comprise:
the auto power generation device(s) as claimed in claim 21 that uses the same voltage (V) and the same (similar) power storage (W/h) as the battery/ies, capacitor(s), transformer(s), power unit(s) used in the manufactoring of the products listed below;
power generator in power station, (portable) electric AC generators, AC generator for electric car(s); electric truck, electric ship, electric van, electric plane, electric spacecraft, AC & DC power generator for factories, (portable) electric AC generators, that are manufactured by replacing the usual (rechargeable) batteries or capacitors and/or, transformer(s), power(s) unit in the products listed above with the auto power generation device(s) as claimed in claim 21, that uses the same (similar) voltage (V) and power storage (W/h) as the (rechargeable) battery/ies, storage capacitor, transformer(s), power unit(s) used initially in the products listed above, to manufacture them functioning continuously without adding external power and called also auto power generation device(s).

23. An other Infinite auto power generation device 11 for the purpose as a mechanical power generator device; that is a new type of electrical motor producing mechanical (and electrical power if connected to a dynamo) continuously without adding continuously external power, that comprise 1 new type of electric motor build with coils made with insulated magnetic alloys wires (for example insulated silicon steel wire or, insulated iron-nickel alloy wire . . . ) that amplify the alternating magnetic fields inside de coils and the cores of the rotor and/or stator of the motor, this results in a stronger magnetic force and a higher power output from the new type of motor, that when connected by their axis to turn a dynamo (as an example), allow the dynamo to give a part of its electrical power to the new type of motor, allowing the continuous production of mechanical and electrical power continuously without adding external power.

24. An Infinite auto power generation device 11 used as AC auto power generation device made with 1 electrical motor build with coils made with insulated magnetic alloys wires, as claimed in claim 23, can be used as a one of the device(s) for the purpose of a process for manufactoring the following products that can function continuously (by having AC & DC electrical power continuously without adding external power) that comprise:
the auto power generation device(s) as claimed in claim 23 that uses the same voltage (V) and the same (similar) power storage (W/h) as the battery/ies, capacitor(s), power unit(s) used in the manufactoring of the products listed below;
electric DC and/or AC power generator and mechanic power generator for/in power station, AC power and mechanical generator and motor for factories, for houses, for (portable) electric DC and/or AC power generator and mechanic generator (motor) in cars, trucks, planes, ships, trains, space craft, washing machine, robots, androids, electric scooter, electric bicycle, electric drill, electric scooter, walkman, electric power generator for computer and laptops and phones, electric power generator for charger of batteries,
that are manufactured by replacing the usual (rechargeable) batteries or capacitors and/or, transformer(s), motor(s), power unit(s) in the products listed above with the auto power generation device(s) as claimed in claim 23, that uses the same (similar) voltage (V) and power storage (W/h) as the (rechargeable) battery/ies, storage capacitors, transformer(s), motor(s), power unit(s) used initially in the products listed above, to manufacture them functioning continuously without adding external power and called also auto power generation device(s)

25. An Infinite auto power generation device 10 for the purpose of producing mechanical power (and electrical power if connected to a dynamo) continuously without adding external power comprise at least:
one circular magnet that has its North pole above and its South magnetic pole below the circular magnet, (or opposite) the circular magnet (s) is/are connected to a rotor that can turn freely around an axis, and at least 1 (or 2) magnets with a rod, or C or U or other form placed with the good angle near the circular magnet with its North magnetic pole above the circular magnet that is showing also its north magnetic pole above, and a 2sd magnet(s) with a rod form, or the same magnet in C or U or other form showing its South magnetic pole below the circular magnet that is showing also its south magnetic pole below (the circular magnet), this produce a magnetic repulsive forces against the circular magnet connected to the rotor, that turns around its axis and generate mechanical power continuously, and its axis can be connected to turn a dynamo to produce electrical and mechanical power continuously without adding external power.

26. An Infinite auto power generation device 10 used as a mechanical power generator device that generate mechanical power continuously and spontaneously with a new model of motor that contains a circular magnet and at least 1 or 2 magnets (with a rod, or C or U or other form), as claimed in claim 25 and in claim 43, can be used as a one of the devices for the purpose of a process for manufactoring the following products that can function continuously (by having mechanical and electrical power continuously without adding external power) that comprise:
the auto power generation device(s) as claimed in claim 25 and in claim 43 that uses the same (similar) voltage (V) and power storage (W/h) as the battery/ies, capacitor(s), motor(s), power unit(s) used in the manufactoring of the products listed below;
mechanical power generator for hydraulic engines, for AC power station, for (portable) AC power station; mechanical power generator (motor, engine) for cars, for trucks, for planes, for ships, for trains, for space craft, for washing machine, for (electric) scooter, for (electric) bicycle, for (electric) drill, for (electric) helicopter, for (electric) drones, that are manufactured by replacing the usual (rechargeable) batteries or capacitors and/or, transformer(s), motor(s), power(s) unit in the products listed above with the auto power generation device(s) as claimed in claim 25, that uses the same (similar) voltage (V) and power storage (W/h) as the (rechargeable) battery/ies, storage capacitors, motor(s), power unit(s) used initially in the products listed above, to manufacture them functioning continuously without adding external power and called also auto power generation device(s),

27. An infinite auto power generation device 13 used as a transformer (and that has also a capacity) for the purpose as generator of HV, high frequency AC & DC or only AC electo (-static) power and/or for increasing or decreasing AC voltage and/or current, that comprise at least:
2 insulated electric conductors (wires, insulated wires, . . . ), that are separated by a HV insulator (paper with paraffin, oil, PET, . . . ), that are together spinned, torsaded, . . . against each other in the middle of their length, while the 2 insulated conductors separated by a HV (anti-static) insulator are being kept isolated in a very HV (anti-static) insulator case (case with paraffine, oil, . . . as examples), or kept on paper with paraffine, the inputs and outputs of this transformers are on the 2 extremities from the 2 insulted wires, that generate in the output (depending on the numbers of spires on each of the 2 conductors): an increased or decreased input voltage and/or current, and whether the polarity at each extremity of each insulted wires of the output of this transformer is DC & AC or only AC voltage, a series of such transformers connected in parallel and/or series s generate continuously and spontaneously HV (static) alternating power without adding external power, and if the 2 insulated wire are identical in size, then only an AC current is created in the output, and if one of the 2 insulated wire is different from the other then a DC & AC current is created in the output, and the insulated wire with the longest, largest size that has a negative − DC & AC voltage and the shortest or smallest insulated wire (conductor) has a positive + DC and AC voltage, the 2 insulated conductors separated by a HV (anti-static) insulator must be kept insulated in a very HV (anti-static) insulator case (case with paraffine, oil, . . . as examples), or kept on paper with paraffine, to produce power continuously without adding external power.

28. An infinite auto power generation device 13 used as a transformer (that has also a capacity) for the purpose of increasing/decreasing and/or generating AC voltage and current and electro (-static) HV power DC & AC or AC only power, as claimed in claim 27, can be used as a one of the devices for the purpose of a process for manufactoring the following products listed below that can function continuously (by having electrical power continuously without adding external power) that comprise:
the auto power generation device(s) as claimed in claim 27 that uses the same voltage (V) and the same (similar) power storage (W/h) as the battery/ies, capacitor(s), power unit(s) used in the manufactoring of the products listed below;
high frequency transformers, very High frequency HV transformers, high frequency high voltage electro-static AC generator, high frequency high voltage s DC & AC generator and transformer, plasma generator, power device for lighting with discharge in gas bulb, air ionizer, that are manufactured by replacing the usual (rechargeable) battery/ies or capacitors and/or, transformer(s), power unit(s) in the products listed above with the auto power generation device(s) as claimed in claim 27, that uses the same (similar) voltage (V) and power storage (W/h) as the (rechargeable) battery/ies, storage capacitors, transformer(s), power unit(s) used initially in the products listed above, and all transformers as claimed in claim 27 have to be kept insulated by a high voltage (HV) (anti-static) insulator to manufacture these products listed above that function continuously without adding external power and these products can also be called auto power generation device.

29. Any other auto power generation device(s) from my invention as claimed in 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51 used together or in combination, (for the purpose of a process for manufactoring devices generating, storing, amplifying AC & DC, high low voltage power and/or HV electrostatic power, electron/ion beam(s), and/or mechanical power continuously without external power), together with the device(s) listed below comprising the infinite auto power generation device(s) from my invention as claimed in claims:
1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51 that used together, or in combination can improve and can lead to increased Power production from this combination, and can be used as a new process of manufactoring improved product.

30. An infinite auto power generation device 7 that comprise at least 1 or more new type of transformers as claimed in claim 21 and in claim 22 for the purpose of generating more power from the circuit as claimed in claim 19 comprise at least 1 to 4 or more new type of transformer using the principle of magnetic amplification in the new type of transformer caused by the use of input coils made with with insulated magnetic alloy wires as claimed in claim 21, that are connected together as claimed in claim 19, (by using the same principle used for DC power to recharge batteries as claimed in claim 1 and claim 3 but applied to AC current), to auto generate more AC power continuously without external power, the increased AC power is at the input and/or output of the 3 new type of transformers (as claimed in claim 21), with same voltage but 3 different output power (W/h) connected in parallel (as claimed in claim 19).

31. An Infinite auto power generation device 7 used as AC generators and storage devices made with transformers as claimed in claims 30 & in claim 21 and in claim 19 and in claim 34, can be used as a one of the devices for the purpose of manufactoring the following products that can function continuously (by having electrical power continuously without adding external power) that comprise:
the infinite auto power generation device(s) as claimed in claim 19 and in claim 21 and in claim 30 and in claim 34, that uses the same voltage (V) and the same (similar) power storage (W/h) as the battery/ies, capacitor(s), transformer(s), power unit(s) used in the manufactoring of the products listed below;
mechanical power generator for hydraulic engines, for AC power station, for (portable) AC power station; mechanical power generator (motor) for cars, for trucks, for planes, for ships, for trains, for space craft, for washing machine, for (electric) scooter, for (electric) bicycle, for (electric) drill, for (electric) helicopter, for (electric) drones, that are manufactured by replacing the usual (rechargeable) batteries or capacitors and/or, transformer(s) power(s) unit in the products listed above with the infinite auto power generation device(s) as claimed in claim 19 and in claim 21 and in claim 30, that uses the same (similar) voltage (V) and power storage (W/h) as the (rechargeable) battery/ies, storage capacitors, transformer(s), power unit(s) used in the products listed above, to manufacture them to function continuously without external power.

32. An infinite auto power generation device 7 that comprise at least 1 or more new type of transformers as claimed in claim 21 for the purpose of generating more power from the motor as claimed in claim 23, that comprise:
at least 1 new type of transformer A, as claimed in claim 20 with its input connected to the electric output of the dynamo(s) generating AC and/or DC power and the dynamo(s) turns by its axis connected to the axis of a new type of motor build with insulated magnetic alloy wire as claimed in claim 23, that get its electric power from (a part of) the AC and/or DC output of at least 1 new type of transformer A as claimed in claim 21, the increased electric output power comes from the output of the new type transformer A as claimed in claim 21 that has its input connected to the electric output of the dynamo, the further increased electric output power comes from the output of the 2sd new type of transformer B (that has its input connected to the output of the first new type of transformer A) as claimed in claim 21, to generate power continuously without adding external power.

33. An infinite auto power generation device 7 used as AC generator and storage device made with transformers as claimed in claim 21 and in claim 23 and in claim 32 and in claim 43, can be used as a one of the devices for the purpose of manufactoring the following products that can function continuously (by having electrical power continuously without adding external power) that comprise:
the auto power generation device(s) as claimed in claim 21 and in claim 23 and in claim 32 and in claim 43, that uses the same voltage (V) and the same (similar) power storage (W/h) as the battery/ies, capacitor(s), power unit(s) used in the manufactoring of the products listed below;
mechanic power generator for hydraulic engines, for electric power station, for (portable) AC power station for factories, and for houses, buildings; mechanical power generator (motor) for cars, for trucks, for planes, for ships, for trains, for space craft, for washing machine, for (electric) scooter, for (electric) bicycle, for (electric) drill, for (electric) helicopter, for (electric) drones, that are manufactured by replacing the usual (rechargeable) batteries or capacitors and/or, transformer(s), motor(s), power(s) unit in the products listed above with the auto power generation device(s) as claimed in claim 21 and in claim 23 and in claim 32, using the (similar) voltage (V) and power storage (W/h) as the (rechargeable) battery/ies, storage capacitors, transformer(s), power unit(s) used initially in the products listed above, to manufacture them to function continuously without adding external power.

34. infinite auto power generation device 7 & 11 combination; made with at least 1 or more new type of transformers as claimed in claim 21 for the purpose of generating more mechanical and electric AC power from the motor as claimed in claim 23 comprise
at least 1 new type of transformer as claimed in claim 21 with, its input connected to the electric output of (a) dynamo(s) generating electrical power and the dynamo(s) is/are connected by its axis to the axis of a new type of motor as claimed in claim 23, the increased electric power output can be collected at the output of the new type of transformer (as claimed in claim 21), and/or at the output of at least 1 more (2sd) new type of transformer as claimed in claim 21, that can have its input connected (to generate further more power) to the output of the 1st new type of transformer, as claimed in claim 21 to generate more increased output AC power continuously without adding external power, that can be partly used to power electrically the new type of motor as claimed in claim 23, this can be repeated many times, by adding and connecting more new type of transformers as claimed in claim 21 to increase further mechanic and AC power output

35. An infinite auto power generation device 8 used as AC power generator producing mechanical and/or AC power, (when connected to a dynamo), continuously and spontaneously made with a rod, or C or U or tube other form and/or diodes and HV insulator and coils, as claimed in claim 15 and in claim 19 and in claim 21 and, that can be used as a one of the devices for the purpose of manufactoring the following products that can function continuously (by having mechanical and AC/DC electrical power continuously without adding external power) that comprise:
the auto power generation device(s) as claimed in claim 15 and in claim 19 and in claim 21 that uses the same (similar) voltage (V) and power storage (W/h) as the (rechargeable) battery/ies, capacitor(s), transformer(s), power unit(s) use in the manufactoring of the products listed below:
AC power generator for portable (high & low) power station, AC power generator for homes, for buildings, for cars, for trucks, for plane, for ships, for trains, for space craft, for washing machine, for electric scooter, for electric bicycle, for electric drill, and electric AC low power generator for electric watches, for calculators, for laptops, for mobile phones, for electric charger for (rechargeable) batteries or (storage) capacitors, for watches, for digital watches, for smart watches, for TV sets, that are manufactured by replacing the usual (rechargeable) batteries or capacitors and/or, transformer(s), motor(s), power(s) unit in the products listed above with the auto power generation device(s) as claimed in claim 15 and in claim 19 and in claim 21, that uses the same (similar) voltage (V) and power storage (W/h) as the rechargeable) battery/ies, storage capacitors, transformer(s), power unit(s) used initially in the products listed above, to manufacture them to function continuously without adding external power and that are also called infinite auto power generation device.

36. An infinite auto power generation device 5 & 7 combination that comprise at least 1 or more new type of transformers as claimed in claim 21 for the purpose of generating power (or amplifying the power from the infinite auto power generation device producing AC power as claimed in claim 17 comprise
at least 1 new type of transformer as claimed in claim 21 with its/their inputs connected to the electric output of the circuit made of
at least 3 capacitors in parallel as claimed in claim 17, and the output of at the least 1 new type of the transformer as claimed in claim 21 can be connected to the input of a 2sd new type of transformer as claimed in claim 21 that produces at its output the further increased power continuously without adding external power, and all capacitors and at least 1 or 2 new type of transformers as claimed in claim 17 and claim 21 have to be kept insulated by a high voltage (HV) (anti-static) insulator to produce an increased power generation continuously without adding external power, more than 1 or 2 new type of transformer build as claimed in claim 21 can be connected in parallel as claimed in claim 21 (and in series s) to increase further the power generated by the infinite power generation device build as claimed in claim 17.

37. An Infinite auto power generation device 9 used as mechanical power generator (a motor) for the purpose of producing mechanical power continuously and spontaneously and made with a circular magnet and at least 1 or 2 magnets (with a rod, or C or U or other form) as claimed in claim 25 and in claim 43 and claim 45, used in combination with new type of transformer(s) as claimed in claim 19 and in claim 21 can be used as a one of the devices for the purpose of manufactoring in the following products that can function continuously (by having electrical power continuously without adding external power) that comprise:
the infinite auto power generation device(s) as claimed in claim 25 and in claim 19 and in claim 21 and in claim 43 and in claim 45 that uses the same (similar) voltage (V) and power storage (W/h) as the (rechargeable) battery/ies, capacitor(s), transformer power unit(s) used in the manufactoring of the products listed below: mechanical power generator for hydraulic engines, for AC power station, for (portable) AC power station; mechanical power generator (motor) for cars, for trucks, for planes, for ships, for trains, for space craft, for washing machine, for (electric) scooter, for (electric) bicycle, for (electric) drill, for (electric) helicopter, for (electric) drones, electro mechanic generator for power station and for factories, and for buildings, and for personal use, that are manufactured by replacing the usual (rechargeable) batteries or capacitors and/or motor and/or power(s) unit in the products listed above by the infinite auto power generation device(s) as claimed in claim 25 and in claim 19 and in claim 21 and claim 43 and in claim 45 that uses the same (similar) voltage (V) and power storage (W/h), mechanical power, as the (rechargeable) battery/ies, storage capacitors, transformer(s), motor(s), power unit(s) used initially in the products listed above, to manufacture these products listed above that can function continuously without adding external power and which are also called infinite auto power generation device.

38. An infinite auto power generation device 12 and infinite auto power generation device 18 for the purpose of amplifying and/or increasing the current and/or voltage generated from the auto power generation device producing DC & AC power as claimed in claim 13 & claim 49 & claim comprise:
at least 1 auto power generation device producing AC power as claimed in claim 13 & 49 that are connected in series s, (and/or parallel), and/or in loop with at least 1 (or more) other auto power generation device as claimed in claim 13 & claim 49 the increased output power comes from the output of the last auto power generation device (disymetric capacitor) as claimed in claim 13, among of all the other auto power generation devices (disymetric capacitor) that are connected in series s, parallel or in loop, and all disymetric capacitors diodes as claimed in claim 13 & claim 49 have to be kept insulated by a high voltage (HV) (anti-static) insulator to generate AC & DC power and/or HV AC electro-static power continuously without adding external power.

39. An infinite auto power generation device 14 made with at least 1 or more (modified) disymetric capacitor as claimed in claim 11 used for the purpose of generating more powerful electron/ion beams continuously without adding external power by combining it with the auto power generation device(s) producing AC power as claimed in claim 13 comprise:
at least 1 disymetric capacitor as claimed in claim 11, that is connected to at least 1 high voltage auto power generation device as claimed in claim 13, made with disymetric capacitor(s) as claimed in claim 9, and the infinite auto power generation device as claimed in claim 13 can also be connected with other auto power generation devices as claimed in claim 13, in loops and/or series s as claimed in claim 13, and all (modified) disymetric capacitors as claimed in claim 9 and in claim 11, and infinite auto generation device as claimed in claim 13 have to be kept insulated with a high voltage (HV) (anti-static) insulator to generate more powerful electron/ion beam continuously without adding external power.

39. An infinite auto power generation device 15 made of one or more disymetric capacitors, as claimed in claim 9 and in claim 11 and in claim 13 and in claim 38, and infinite auto power generation device 18, as claimed in claim 1 & claim 49 can be used as a one of the devices for the purpose of manufactoring in the following products that can function continuously (by having HV electrical and electro-static power continuously without adding external power) that comprise the infinite auto power generation device(s) as claimed in claim 9 and in claim 11 and in claim 13 & 38 & 49 that uses the same voltage (V) and the same (similar) power storage (W/h) as the usual high voltage power unit(s) used in the manufactoring of the products listed below;
air ionizer, electron beam generator, ion beam generator, ionic trust engine for space, plasma generator, High voltage generator, high energy pulse laser, power device for flash light in camera, very high intensity laser pulse device, spark generators, high Voltage electrostatic generator for photocopy machine, that are manufactured by replacing the usual (rechargeable) battery/ies or capacitors and/or power unit(s) in the products listed above by the auto power generation device(s), diodes and disymetric capacitors as claimed in claim 9 and in claim 11 and in claim 49 and claim 13 and in claim 38, that uses the same (similar) voltage (V) and power storage (W/h) as the high voltage power unit(s) used initially in the products listed above, to manufacture these products that can function continuously without adding external power, which are also called infinite auto power generation device.

41. An infinite auto power generation device 13 made with at least 2 or more transformers as claimed in claim 27 for the purpose of generating more DC & AC or AC (only) high voltage (electrostatic) power without adding external power comprise at least:
2 transformers as claimed in claim 27, that are connected in parallel and/or in loop(s), by connecting in parallel the output of 1 transformer as claimed in claim 27 to the input of the 2sd transformer as claimed in claim 27 and one or both of the inputs of the 1rst transformer as claimed in claim 27 can be connected to diode, zener diode, capacitors, or other electronic components, to produce at the output of one of the other transformers (as claimed in claim 27) DC current, or current with triangular, dent, sinus wave with a higher voltage, current than at the input of the 1rst transformer as claimed in claim 27, and all transformers as claimed in claim 27 have to be kept insulated by a high voltage (HV) (anti-static) insulator to transform and generate power continuously without adding external power.

42. An infinite auto power generation device 13 made with a transformer (that has also a capacity) for the purpose of increasing and decreasing and/or generating voltage and/or current and (static) HV power DC & AC or AC only power generation, as claimed in claim 27 and in claim 41, and infinite auto power generation device 18 as claimed in claim 1 & claim 49 can be used as a one of the devices for the purpose as a process for manufactoring the following products that can function continuously (by having electrical power continuously without adding external power) that comprise:
the infinite auto power generation device(s) as claimed in claim 27 and in claim 41 or infinite auto power generation device 18 as claimed in claim 1 & claim 49 that uses the same voltage (V) and the same (similar) power storage (W/h) as batteries, capacitor(s), transformer (s) power unit(s) used in the manufactoring of the products listed below;
high frequency transformers, very High frequency HV transformers, high frequency high voltage static AC generator, high frequency high voltage DC & AC generator and transformer, plasma generator, power device for lighting with discharge in gas bulb, air ionizer, high voltage generator for thrust engine in space using electron/ion beam for thrust in space, that are manufactured by replacing the usual (rechargeable) battery/ies or transformer, capacitors and/or power unit(s) in the products listed above with the auto power generation device(s) as claimed in claim 27 and in claim 41, claim 49, that uses the same (similar) voltage (V) and power storage (W/h) as the (rechargeable) batteries storage capacitors, transformer(s), power unit(s) used initially in the products listed above, and all transformers as claimed in claim 27 and in claim 41 & claim 49 have to be kept insulated by a high voltage (HV) (anti-static) insulator to manufacture these products listed above that function continuously without adding external power.

43. An infinite auto power generation device 10 for the purpose of mechanical and electric power generation continuously and spontaneously without added external energy is a new type of motor as claimed in claim 25 and AC power generator that comprise:
a circular magnet, (on a rotor and axis) as claimed in claim 25, with a succession of holes separated by no holes with the same hole's diameter along its circumference, the 4 extremities (with the size of the diameter of a hole) of 2 same inverted coils in series & with both a C shape core are near each other & facing simultaneously a hole and not a hole (repeatedly) if the circumference of the circular magnet is turning, this creates an induction AC in the 2 inverted coils in series with a C shape core, and at least 1 or 2 (or more) magnets in a rod or U, . . . form that can be pre-fixed or that are placed by adjusting around their axis (manually with a adjust knob) in the angle that allow magnetic repulsive forces below and above the circular magnet and rotor to rotate freely around its axis, where 1 or more magnet in a U or C form:
has its extremity with South magnetic pole placed below the circular magnet showing also its South magnetic pole, (or opposite for C form &circular magnet)
while the same magnet in a C or U shows its extremity with its North magnetic pole placed above the circular magnet showing also above its North magnetic pole (or opposite for C form & circular magnet)
1 or 2 more other magnet(s) in a U or C or other form that can be placed in the angle and direction that allow magnetic attractive forces below and above the circular magnet and rotor to be able to rotate freely around its axis, by having:
1 or 2 (or more) other magnets in a C or U form with its extremity with North magnetic pole placed below the circular magnet that is showing its South magnetic pole, (or opposite for C form & circular magnet)
while the same 1 or 2 (or more) other magnets in a C or U or other form shows its extremity with its South magnetic pole placed above the circular magnet that is showing above its North magnetic pole, (or opposite for C form &circular magnet) these 2 or 4 (or more) magnet(s) in a U or C or other form) are placed near/close to the circular magnet with the angle/direction that allow magnetic repulsive & attractive forces both below and above the circular magnet and rotor to be able to rotate freely around its axis, to generate more mechanical power from this improved infinite auto power generation device/motor, the magnets in a rod or C or U or other form allowing repulsive and/or attractive magnetic forces against the circular magnet can also be fixed at the middle of their length (at the bend extremity of the magnet in C or U or other form) with an axis, and adjust knob, allowing it to move/turn (manually or remotely) by an angle of about 90 degrees around its axis in 2 different direction and/or position against the circular magnet, that allows the circular magnet and the rotor to rotate freely around its axis in one or the opposite direction; clockwise or anti-clockwise, the magnet(s) in C or U form creating repulsive and/or attractive magnetic forces against the circular magnet can also be fixed an moved/placed or turned around its/their axis (manually with adjust knob or remotely) by an angle between 0 and 180 degrees from their usual direction/position against the circular magnet, to allow the circular magnet and the rotor to rotate freely around its axis with less or more power, or speed or in one or the opposite direction, or to stop it rotating by lowering or increasing or inverting or stopping the magnetic repulsive and/or attractive forces from the magnet(s) in C or U or other form against the circular magnet, this is done by changing the angles and distances of repulsion (and/or attraction) of the magnetic forces of magnet(s) with a C or U or other form against the circular magnet rotating around its axis, the rotor and circular magnet turning freely around its axis continuously without adding external, is producing a rotating mechanical power continuously that can is converted to electrical power by the 2 (or more) coils with a C shaped core facing the holes and no holes repeatedly along the circumference of the turning circular magnet of the motor (made with 2 or 3 or more magnets) with its produced AC electric power output connected to the input of the new type of transformer (A) as claimed in claim 21, the further increased electric power from the infinite auto power generation motor (made with magnets) comes from the electric output of the new type of transformer (A) as claimed in claim 21.

44. An Infinite auto power generation device 10 for the purpose of mechanical power generation and as AC power generator continuously and spontaneously without added external energy is a new type of motor as claimed in claim 25 and dynamo as claimed in claim 43 that comprise:
the infinite auto power generation device(s) as claimed in claim 25 and in claim 43 that uses the same (similar) power storage (W/h) as the usual motor(s), power unit(s) used in the manufactoring of the products listed below;
mechanic power generator for hydraulic engines, electric power station, (portable) AC power station for factories, for houses, for buildings; mechanical and AC power generator (motor) for electric or not electric cars, trucks, planes, ships, trains, space craft, washing machine, (electric) scooter, (electric) bicycle, (electric) drill, (electric) helicopter, (electric) drones, motor with variable speed & power output; motor and AC generator for power station, motor and AC generator for portable AC/DC power generator, motor for spaceship, motor that are manufactured by replacing the usual (rechargeable) battery/ies or capacitors, motor(s) and/or power unit(s) in the products listed above by the auto power generation device(s) as claimed in claim 25 and in claim 43, that uses the same (similar) voltage (V) and power storage (W/h), power output (W/h), (Kw/h) as used initially in the products listed above, to manufacture these products that can function continuously without adding external power.

45. An Infinite auto power generation device 2 made with at least (rechargeable) 4=2×2 battery/ies for the purpose of generating and/or storing DC power or as charger device producing DC power continuously without adding external power comprise at least:
2 (rechargeable) batteries W & X with same voltage and same power storage; (12 V, 60 A, as example) connected in series,
2 batteries (or storage capacitors) Y, Z (with same voltage and same power storage but different from power storage of batteries W & X; (12V, 40 A, as example) connected in series,
pole − of battery X is connected to pole − of battery Z
pole + of battery W is connected to pole + of battery Y Both 0 Volt (GRD) of battery W & X and Y & Z are connected together to 2 diodes;
with 1 diode's cathode to pole − of battery X & Z and
1 other diode's anode to pole + of batteries W & Y,
1 switch connects 1 diodes to pole + of battery W & Y,
a 2sd switch connect the 2sd diode to pole − of battery X & Z,
the switches are off when batteries W & X & Y & Z are charged, these 2 switches can be replaced by other similar circuits.

46. An infinite auto power generation device 2, as claimed in claim 45 and infinite auto power generation device 17 as claimed in claim 1 & claim 47 & claim 50; with a voltage of about 1 V to 50 volt, can be used as a one of the devices for the purpose of manufactoring the following products that can function continuously (by having DC electrical power continuously without adding external power) that comprise at least:
the infinite auto power generation device(s) 2 as claimed in claim 45 that uses the same (similar) voltage (V) and power storage (W/h) as the usual (rechargeable) battery/ies or power unit used in the manufactoring of the products listed below; mobile phone, laptops, printers, electric drill, electric torch, watches, smart watches, handheld calculator and computer, translator, camera, electric bicycles, car and truck battery, TV sets, electric pump, toys battery charger, A and AA and AAA battery charger, rechargeable A and AA and AAA battery charger, electric compressor battery charger, androids battery charger, drones battery charger, robots battery charger, electric car battery charger, electric planes battery charger, electric scooter battery charger, electric bicycle battery charger, that are manufactured by replacing or recharging the usual (rechargeable) battery/ies or capacitor(s) and/or power unit(s) in the products listed above with the auto power generation device(s) as claimed in claim 2 that use(s) the same (similar) voltage (V) and power storage (W/h) as the usual (rechargeable) battery/ies or power battery/ies or power unit(s) used initially in the products listed above, to manufacture these products that can function continuously without adding external power that can be called infinite auto power generation device.

47. An infinite auto power generation device 2, and infinite auto power generation device 17 as claimed in claim 45 & claim 50 with a voltage of about 1 V to 750 volt (V), can be used as a one of the devices for the purpose of manufactoring the following products that can function continuously (by having DC electrical power continuously without adding external power) that comprise at least:
the auto power generation device(s) as claimed in claim 2 that uses the same (similar) voltage (V) and power storage (W/h) as the usual (rechargeable) battery/ies or power unit used in the manufactoring of the products listed below; electric bicycles battery and battery charger, car & van & plane & ships & train, truck's battery, battery charger; light radio TV mobile phones battery, electric pump's battery and battery charger, toy's battery and battery charger, electric compressor battery and battery charger, robot's battery and battery charger, drones battery and battery charger, electric car battery charger, electric planes battery and battery charger, electric scooter battery and battery charger, wind turbine battery and battery charger, solar& hydro & hydrogene power station battery & battery charger, wind turbine storage battery and battery charger, factory robot battery and battery charger, electric power station generator & electric power station battery charger, robot & android battery that are manufactured by replacing or recharging the usual (rechargeable) battery/ies or capacitor(s) and/or power unit(s) in the products listed above with the auto power generation device(s) as claimed in claim 2 and that use(s) the same (similar) voltage (V) and power storage (W/h) as the usual (rechargeable) battery/ies or power battery/ies or power unit(s) used initially in the products listed above to manufacture these products that can function continuously without adding external power and that can be called infinite auto power generation device.

48. An infinite auto power generation device 19 build as example with at least 4 (rechargeable) battery/ies with a voltage of about 1 V to 750 volt (V), 5 NPN transistors, 3 PNP transistors, 11 diodes, 3 capacitors, 13 resistors for the purpose of generating and/or storing AC power by letting the DC current from 2 infinite auto power generation device 17 alternate to generate a continuous alternating current without adding external power.

49. An infinite auto power generation device 18, as claimed in claim 1, is made of at least 2 inverted fast switching diodes in parallel, that is used as DC power generator that produce at its anode with a metal ring and its cathode a point an electron beam in the air when both inverted diodes are kept in or on HV insulation.

50. An infinite auto power generation device 17, as claimed in claim 1; comprise as an example at least:
2 or 3 (rechargeable) batteries in series s with between them at least 1 or 2 diodes & 1 (electrolytic) capacitor connected with the emitter of the (NPN) transistor and to the cathodes of at least 1 or 2 diodes in parallel and − pole of the (electrolytic) capacitor while the collector of the (NPN) transistor is connected to the anode of the at least 1 or 2 diodes in parallel and the + of electrolytic capacitor, and a resistor connected to the base of the (NPN) is at its other extremity connected to pole + of the capacitor. The rechargeable battery/ies to recharge has its pole + connected to the pole + of the first battery in series and the pole − other the other battery in series is connected to the pole − of the battery/ies to recharge. The diodes, capacitor, transistor can be replaced by many diodes in parallel that have their cathode connected to the pole − of 1 battery and their anode connected to the pole + between the 2 (rechargeable) batteries in series s, these diodes can be on an integrated circuit. An other integrated circuit that contain the diodes, capacitor, transistor can also be used between the at least 2 batteries in series,

51. One or more infinite auto power generation device 19, as claimed in claim 48; can be connected in parallel with one or more infinite auto power generation device 6 and or infinite auto power generation device 19 to generate more electric power.
